(19) United States
(12) Patent Application Publication
(10) Pub. No.: US 2018/0232139 A1
(43) Pub. Date: Aug. 16, 2018

(54) WINDOW CONTROL METHOD, INFORMATION PROCESSING APPARATUS, AND CONTROL METHOD AND CONTROL PROGRAM OF INFORMATION PROCESSING APPARATUS

(71) Applicant: NEC Corporation, Tokyo (JP)

(72) Inventor: Yoshifumi OKUDA, Tokyo (JP)

(73) Assignee: NEC Corporation, Tokyo (JP)

(21) Appl. No.: 15/511,478

(22) PCT Filed: Sep. 4, 2015
(86) PCT No.: PCT/JP2015/075235

§ 371 Date: Mar. 15, 2017

(30) Foreign Application Priority Data
Sep. 16, 2014 (JP) 2014-188307

(51) Int. Cl. G06F 3/0488; G06F 3/0481

(52) U.S. Cl. CPC G06F 3/04886; G06F 2203/04803; G06F 3/0481

(57) ABSTRACT

An apparatus of this invention is directed to an information processing apparatus that discriminates, without adding any hardware component, between a window to be operated and a window not to be operated. The information processing apparatus includes a display unit that displays at least two windows, a determiner that determines a touch for maintaining screen on a display region of the at least two windows, and a controller that maintains, even when an operation for the at least two windows is input, display of a window on which the touch for maintaining screen has been determined, regardless of the operation. The controller executes the input operation for a window on which the touch for maintaining screen has not been determined.

### TECHNICAL FIELD

The present invention relates to a window control method, an information processing apparatus, and a control method and control program of the information processing apparatus.

### BACKGROUND ART

In the above technical field, patent literature 1 discloses a technique of detecting a gripping region by a side sensor, and setting the gripping region as a fixed region and a releasing region other than the gripping region as a region where scroll is permitted.

### CITATION LIST

### Patent Literature

Patent literature 1: Japanese Patent Laid-Open No. 2014-049027

### SUMMARY OF THE INVENTION

### Technical Problem

However, the technique described in the above literature cannot discriminate between the fixed region and the releasing region unless a hardware component such as a side sensor is added.

The present invention enables to provide a technique of solving the above-described problem.

### Solution to Problem

One aspect of the present invention provides an information processing apparatus comprising:

a display unit that displays at least two windows;

a determiner that determines a touch for maintaining screen on a display region of the at least two windows; and

a controller that maintains, if an operation for the at least two windows is input, display of a window on which the touch for maintaining screen has been determined, regardless of the operation.

Another aspect of the present invention provides a method of controlling an information processing apparatus, comprising:

displaying at least two windows;

determining a touch for maintaining screen on a display region of the at least two windows; and

maintaining, even when an operation for the at least two windows is input, display of a window on which the touch for maintaining screen has been determined, regardless of the operation.

Still other aspect of the present invention provides a program of controlling an information processing apparatus for causing a computer to execute a method, comprising:

displaying at least two windows;

determining a touch for maintaining screen on a display region of the at least two windows; and

maintaining, even when an operation for the at least two windows is input, display of a window on which the touch for maintaining screen has been determined, regardless of the operation.

Still other aspect of the present invention provides a method of controlling windows comprising:

determining a touch for maintaining screen on display regions of at least two windows; and

maintaining, even when an operation for the at least two windows is input, display of a window on which the touch for maintaining screen has been determined, regardless of the operation.

### Advantageous Effects of Invention

According to the present invention, it is possible to discriminate, without adding any hardware component, between a window to be operated and a window not to be operated.

### BRIEF DESCRIPTION OF DRAWINGS

FIG. 1 is a block diagram showing the arrangement of an information processing apparatus according to the first embodiment of the present invention;

FIG. 2 is a view showing a screen maintaining operation of an information processing apparatus according to the second embodiment of the present invention;

FIG. 3 is a block diagram showing the functional arrangement of the information processing apparatus according to the second embodiment of the present invention;

FIG. 4 is a table showing the structure of display frame information according to the second embodiment of the present invention;

FIG. 5 is a table showing the structure of a maintaining determination table according to the second embodiment of the present invention;

FIG. 6 is a block diagram showing the hardware arrangement of the information processing apparatus according to the second embodiment of the present invention;

FIG. 7 is a flowchart illustrating the processing procedure of the information processing apparatus according to the second embodiment of the present invention;

FIG. 8 is a flowchart illustrating a display frame control procedure according to the second embodiment of the present invention;

FIG. 9 is a view showing a screen maintaining operation of an information processing apparatus according to the third embodiment of the present invention;

FIG. 10 is a table showing the structure of display frame information according to the third embodiment of the present invention;

FIG. 11 is a flowchart illustrating the processing procedure of the information processing apparatus according to the third embodiment of the present invention;

FIG. 12 is a view showing a screen maintaining operation of an information processing apparatus according to the fourth embodiment of the present invention;

FIG. 13 is a table showing the structure of display frame information according to the fourth embodiment of the present invention;

FIG. 14 is a flowchart illustrating the processing procedure of the information processing apparatus according to the fourth embodiment of the present invention;

FIG. 15 is a view showing a screen maintaining operation of an information processing apparatus according to the fifth embodiment of the present invention;

FIG. 16 is a table showing the structure of display frame information according to the fifth embodiment of the present invention;

FIG. 17 is a flowchart illustrating the processing procedure of the information processing apparatus according to the fifth embodiment of the present invention;

FIG. 18 is a view showing a screen maintaining operation of an information processing apparatus according to the sixth embodiment of the present invention;

FIG. 19 is a table showing the structure of a maintaining determination table according to the sixth embodiment of the present invention;

FIG. 20 is a flowchart illustrating the processing procedure of the information processing apparatus according to the sixth embodiment of the present invention;

FIG. 21A is a view showing a screen maintaining operation of an information processing apparatus according to the seventh embodiment of the present invention;

FIG. 21B is a view showing another screen maintaining operation of the information processing apparatus according to the seventh embodiment of the present invention;

FIG. 22 is a view showing the structure of display frame information according to the seventh embodiment of the present invention;

FIG. 23A is a view showing a screen maintaining operation for the 3-division screen of an information processing apparatus according to the eighth embodiment of the present invention;

FIG. 23B is a view showing a screen maintaining operation for the 4-division screen of an information processing apparatus according to the eighth embodiment of the present invention;

FIG. 23C is a view showing a screen maintaining operation for a superimposed screen of an information processing apparatus according to the eighth embodiment of the present invention;

FIG. 23D is a view showing another screen maintaining operation for a superimposed screen of an information processing apparatus according to the eighth embodiment of the present invention;

FIG. 24 is a view showing a screen maintaining operation at the time of a software key operation of an information processing apparatus according to the eighth embodiment of the present invention;

FIG. 25 is a view showing a screen maintaining operation at the time of a rotation operation of an information processing apparatus according to the eighth embodiment of the present invention;

FIG. 26 is a view showing a screen maintaining operation of an information processing apparatus according to the ninth embodiment of the present invention;

FIG. 27 is a block diagram showing the functional arrangement of the information processing apparatus according to the ninth embodiment of the present invention;

FIG. 28 is a table showing the structure of display frame information according to the ninth embodiment of the present invention;

FIG. 29 is a flowchart illustrating the processing procedure of the information processing apparatus according to the ninth embodiment of the present invention;

FIG. 30 is a flowchart illustrating a display frame control procedure according to the ninth embodiment of the present invention; and

FIG. 31 is a view showing screen maintaining and sound maintaining operations of an information processing apparatus according to the 10th embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise. Note that a “display frame” used in this specification is synonymous with a window.

### First Embodiment

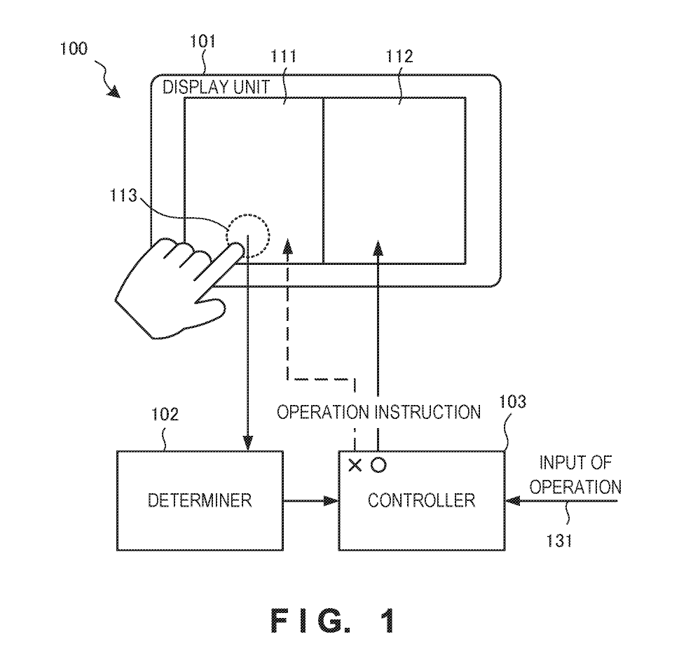

An information processing apparatus 100 according to the first embodiment of the present invention will be described with reference to FIG. 1. The information processing apparatus 100 is an apparatus for displaying a window.

As shown in FIG. 1, the information processing apparatus 100 includes a display unit 101, a determiner 102, and a controller 103. The display unit 101 displays at least two windows 111 and 112. The determiner 102 determines a touch 113 for maintaining screen on the display region of the at least two windows. If an operation 131 for the at least two windows is input, the controller 103 maintains the display of a window 111 on which the touch 113 for maintaining screen has been determined, regardless of the operation 131. Note that a touch for maintaining screen is also called as a screen maintaining touch, hereinafter.

According to this embodiment, since display is maintained by a screen maintaining touch, it is possible to discriminate, without adding any hardware component, between a window to be operated and a window not to be operated.

### Second Embodiment

An information processing apparatus according to the second embodiment of the present invention will be described next. If a window erase operation for the divided screens of two windows is performed, the information processing apparatus according to this embodiment maintains display of the window on which a screen maintaining touch has been performed, and erases the window on which no screen maintaining touch has been performed.

<<Screen Maintenance Operation>>

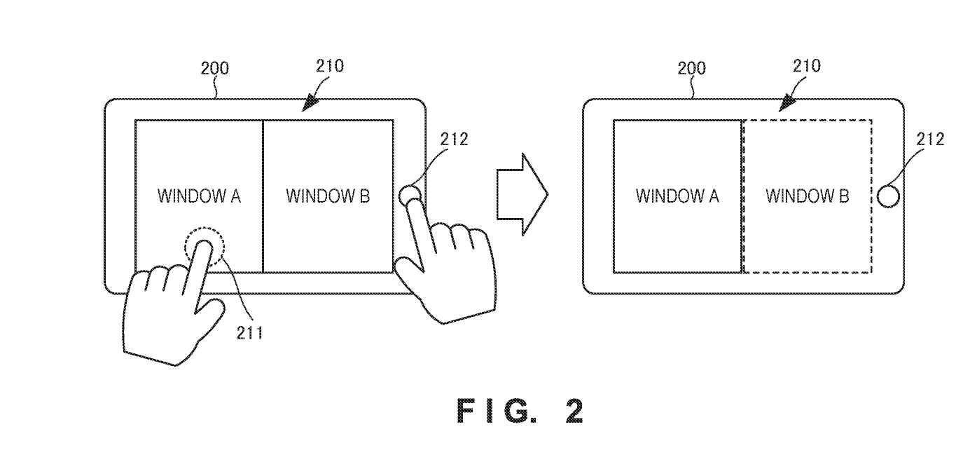

FIG. 2 is a view showing a screen maintaining operation of an information processing apparatus 200 according to this embodiment. FIG. 2 shows, from left, a screen maintaining touch on a divided screen and a screen erase operation→screen maintaining and screen erase.

Windows A and B are divisionally displayed on a display screen 210 of the information processing apparatus 200. In a state in which the user performs a screen maintaining touch 211 on window A, he/she presses a home button 212 (see the left view). In response to the screen maintaining touch 211 and the pressing of the home button 212, the display of window A is maintained and window B is erased (the right view). Note that the operation of an application which has opened window B is continued.

<<Functional Arrangement of Information Processing Apparatus>>

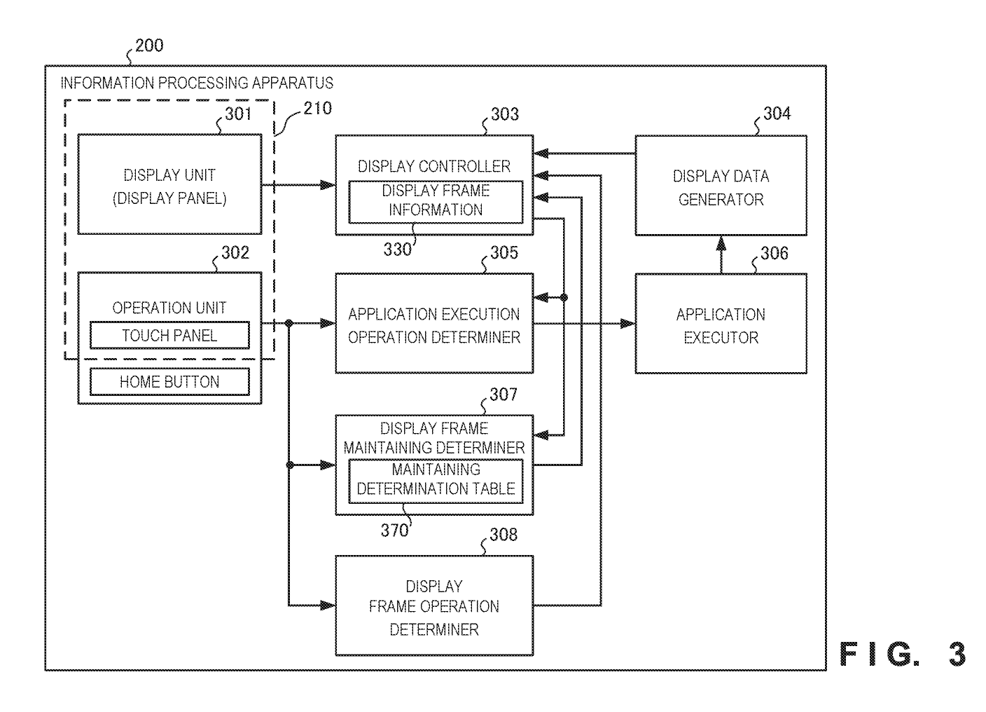

FIG. 3 is a block diagram showing the functional arrangement of the information processing apparatus 200 according to this embodiment.

The information processing apparatus 200 includes a display unit 301 with a display panel, and an operation unit 302 with a touch panel, a home button, and the like. Among them, the display panel and the touch panel form the display screen 210. The information processing apparatus 200 includes a display controller 303, a display data generator 304, an application execution operation determiner 305, and an application executor 306.

The application execution operation determiner 305 determines an application execution operation in the operation unit 302. In the case of the application execution operation, the application executor 306 activates an application, and executes it. The display data generator 304 generates display data according to the executed application. The display controller 303 has display frame information 330, assigns, to a display frame, the display data generated by executing the application, and displays the display data on the display unit 301, thereby implementing window control.

The information processing apparatus 200 also includes a display frame maintaining determiner 307 and a display frame operation determiner 308. The display frame maintaining determiner 307 has a maintaining determination table 370, and determines screen maintaining based on an operation in the operation unit 302. The display frame operation determiner 308 determines an instructed operation based on an operation in the operation unit 302. In this example, erase of a window will be exemplified as the operation.

Even if the display frame operation determiner 308 determines a window erase operation, the display controller 303 does not erase the display frame (window) for which a screen maintaining operation has been performed by the display frame maintaining determiner 307, and erases the display frame (window) for which no screen maintaining operation has been performed. With this processing, it is possible to discriminate, by a simple operation, between a window to be erased and a window not to be erased.

(Display Frame Information)

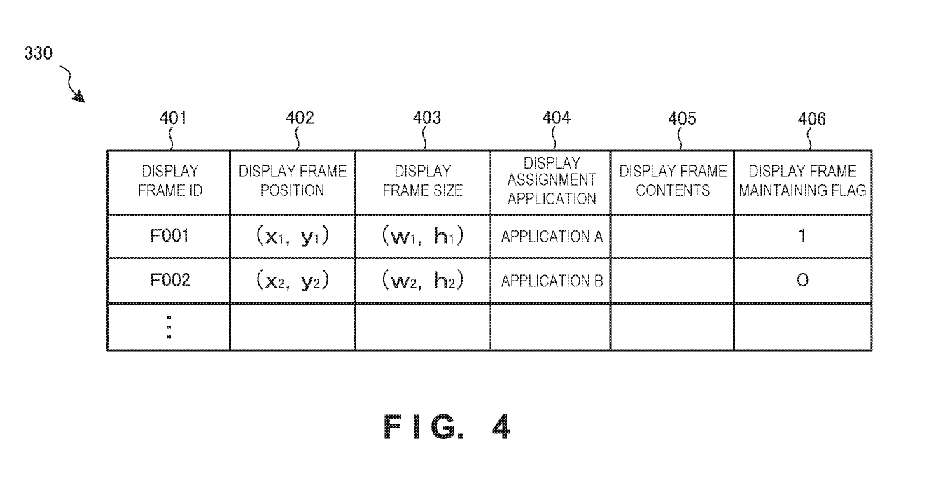

FIG. 4 is a view showing the structure of the display frame information 330 according to this embodiment. The display frame information 330 is used by the display controller 303 to arrange display information related to an application on a screen. Note that in FIG. 4, for each display frame, different numerical values are set also in a frame display position and frame size in the y-axis direction (vertical direction) in order to maintain the generality. However, in the case of the divided screens in the x-axis direction (horizontal direction) shown in FIG. 2, the same values of y and h are set for all display frames.

The display frame information 330 stores a display frame position 402 and a display frame size 403 in association with a display frame ID 401. Note that a display position may be the upper left of a display frame but is not limited to this. In addition, instead of the display frame position 402 and the size 403, two display positions of corners of the display frame may be stored.

The display frame information 330 stores, in association with the display frame ID 401, as a display assignment application 404, an application for generating information to be displayed on the display frame. Frame contents 405 generated by the application are stored.

The display frame information 330 stores, for each display frame, a display frame maintaining flag 406 based on the screen maintaining touch. In this example, if the display frame maintaining flag 406 is “1”, screen maintaining is performed. Alternatively, if the display frame maintaining flag 406 is “0”, an operation such as an erase operation is complied with.

(Maintenance Determination Table)

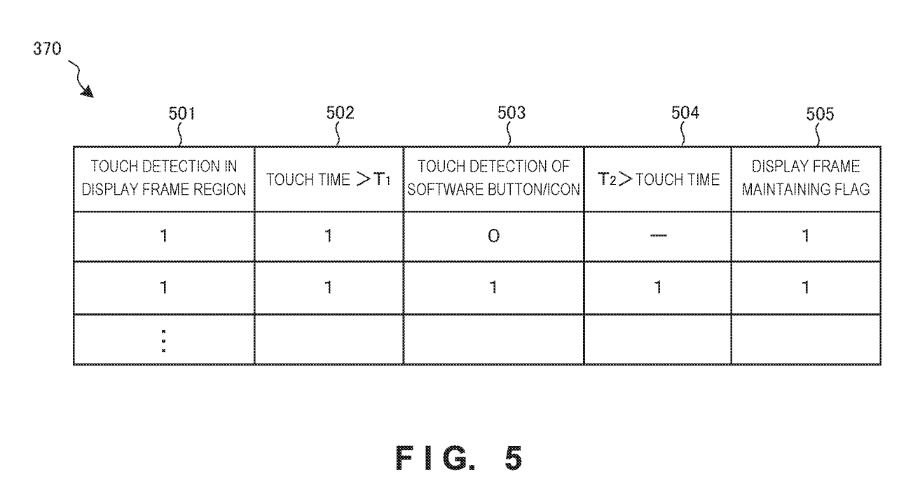

FIG. 5 is a table showing the structure of the maintaining determination table 370 according to this embodiment. The maintaining determination table 370 stores conditions for setting the display frame maintaining flag 406 to “1”, thereby determining that a screen maintaining operation has been performed. FIG. 5 shows conditions for determining a screen maintaining operation.

The maintaining determination table 370 stores touch detection 501 in a display frame region, and data 502 indicating whether a touch time exceeds a threshold T1. If a touch in the display frame region is detected and a touch time exceeds the threshold T1, a screen maintaining touch operation is determined. However, if touch detection 503 is determined in the display frame region but it is determined within a range of a software button, an icon, or the like, data 504 indicating whether a touch time is shorter than a threshold T2 (>T1) is set as a condition. That is, if a touch on a software button, an icon, or the like is performed and a touch time is equal to or longer than the threshold T2, an operation on the software button, the icon, or the like is determined. The maintaining determination table 370 stores a display frame maintaining flag 505 as a screen maintaining determination result.

Note that the screen maintaining operation determination conditions are not limited to them. For example, a status in which a screen operation such as a screen erase operation is performed in the divided screen may be set as a condition.

<<Hardware Arrangement of Information Processing Apparatus>>

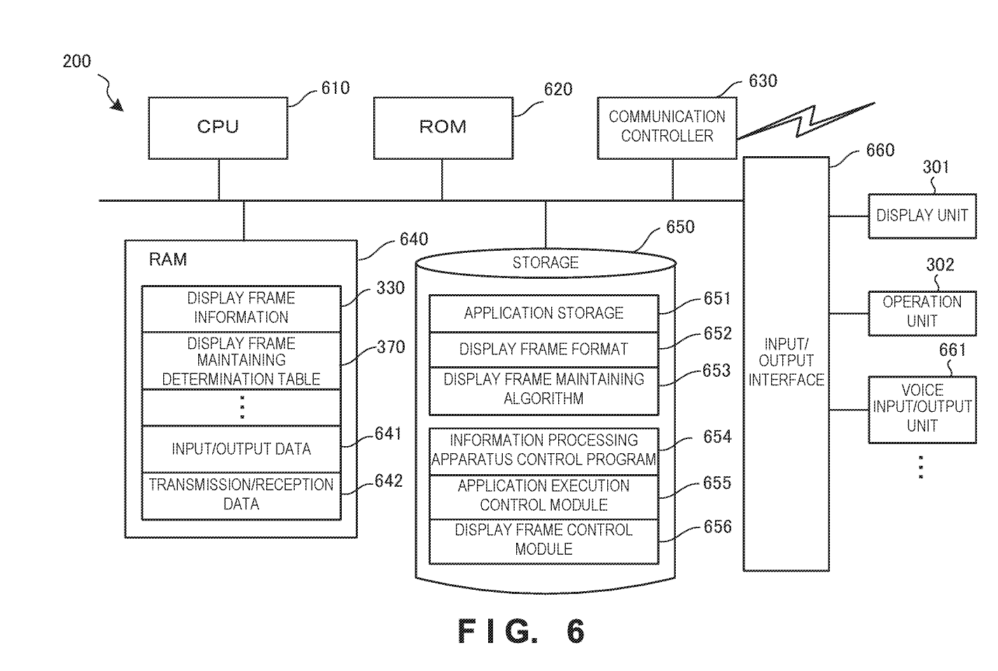

FIG. 6 is a block diagram showing the hardware arrangement of the information processing apparatus 200 according to this embodiment.

Referring to FIG. 6, a CPU (Central Processing Unit) 610 is an arithmetic control processor, and implements the functional components of the information processing apparatus 200 shown in FIG. 3 by executing a program. A ROM (Read Only Memory) 620 stores permanent data such as initial data and a program, and programs. A communication controller 630 communicates with another apparatus via a network. Note that the number of CPUs 610 is not limited to one, and a plurality of CPUs or a GPU (Graphic Processing Unit) for image processing may be included. The communication controller 630 desirably includes a CPU independent of the CPU 610, and writes or reads out transmission/reception data in or from the area of a RAM (Random Access Memory) 640. It is desirable to provide a DMAC (Direct Memory Access Controller) (not shown) for transferring data between the RAM 640 and a storage 650. Furthermore, an input/output interface 660 desirably includes a CPU independent of the CPU 610, and writes or reads out input/output data in or from the area of the RAM 640. Therefore, the CPU 610 processes the data by recognizing that the data has been received by or transferred to the RAM 640. Furthermore, the CPU 610 prepares a processing result in the RAM 640, and delegates succeeding transmission or transfer to the communication controller 630, DMAC, or input/output interface 660.

The RAM 640 is a random access memory used as a temporary storage work area by the CPU 610. An area to store data necessary for implementation of the embodiment is allocated to the RAM 640. The display frame information 330 stores the definition of a display frame including an enlarged display frame to be superimposed and displayed, and the relation with an application. The display frame maintaining determination table 370 is a table for determining screen maintaining. Input/output data 641 are data transferred to/from the display unit 301 and the operation unit 302 via the input/output interface 660. Transmission/reception data 642 are data transmitted/received via the communication controller 630.

The storage 650 stores a database, various parameters, or the following data or programs necessary for implementation of the embodiment. An application storage 651 stores applications executed by the information processing apparatus 200. A display frame format 652 stores the formats of the display frames stored in the display frame information 330. A display frame maintaining algorithm 653 stores a screen maintaining determination algorithm.

The storage 650 stores the following programs. An information processing apparatus control program 654 is a basic program for controlling the overall information processing apparatus 200. An application execution control module 655 is a module for executing applications stored in the application storage 651. A display frame control module 656 is a module for controlling the arrangement, on the display unit 301, of the display frames assigned with pieces of display information generated by executing the applications and, in this example, controls screen maintaining and screen erase in accordance with the display frame maintaining flags.

The input/output interface 660 interfaces input/output data with an input/output device. The input/output interface 660 is connected to the display unit 301, the operation unit 302, a voice input/output unit 761, and the like. A GPS (Global Positioning System) position determiner may also be connected.

Note that programs and data which are associated with the general-purpose functions of the information processing apparatus 200 and other feasible functions are not shown in the RAM 640 or the storage 650 of FIG. 6.

<<Processing Procedure of Information Processing Apparatus>>

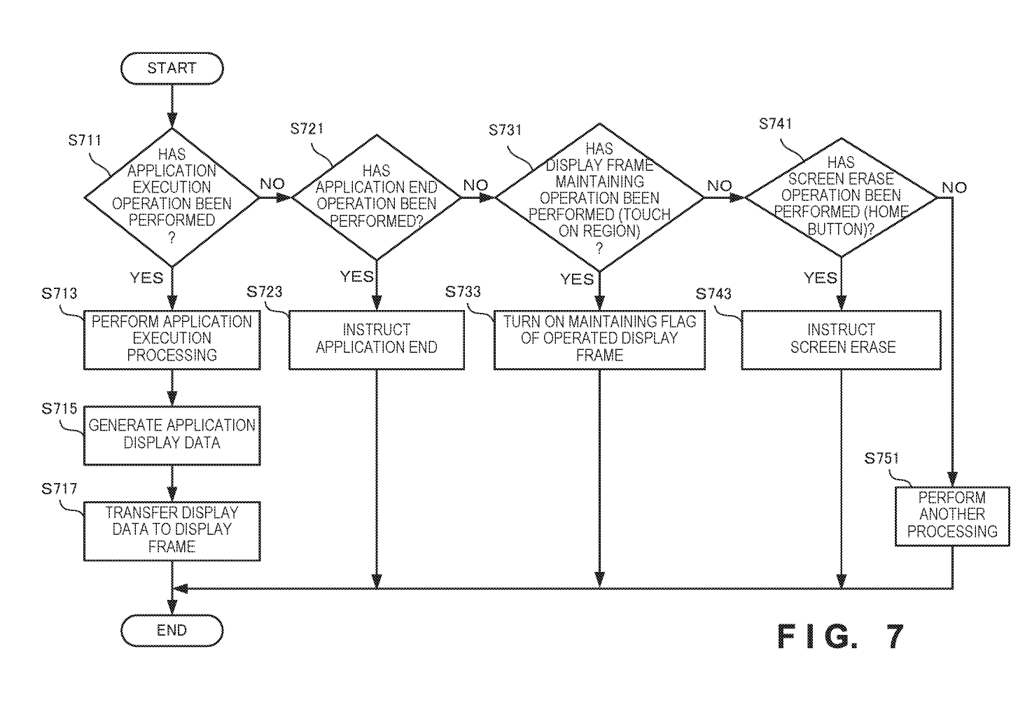

FIG. 7 is a flowchart illustrating the processing procedure of the information processing apparatus 200 according to this embodiment. This flowchart is executed by the CPU 610 of FIG. 6 using the RAM 640, thereby implementing the functional components of FIG. 3.

In step S711, the information processing apparatus 200 determines whether an application execution operation has been performed on a display screen. If an application execution operation has been performed, the information processing apparatus 200 executes an instructed application in step S713. In step S715, the information processing apparatus 200 generates display data related to execution of the application. In step S717, the information processing apparatus 200 transfers the generated display data to display it in an assigned display frame.

If no application execution operation has been performed, the information processing apparatus 200 determines in step S721 whether an operation of ending the currently executed application has been performed. If the operation of ending the currently executed application has been performed, the information processing apparatus 200 instructs end of the currently executed application in step S723.

If neither an application execution operation nor an application end operation has been performed, the information processing apparatus 200 determines in step S731 whether a screen maintaining operation has been performed in the window. If it is determined that the screen maintaining operation has been performed, in step S733 the information processing apparatus 200 sends a notification of the display frame for which the screen maintaining operation has been performed, and turns on the display frame maintaining flag.

If none of an application execution operation, an application end operation, and a display frame maintaining operation has been performed, the information processing apparatus 200 determines in step S741 whether a screen erase operation has been performed. If a screen erase operation has been performed, in this example, upon the pressing of the home button, the information processing apparatus 200 instructs screen erase in step S743.

If none of an application execution operation, an application end operation, a display frame maintaining operation, and a screen erase operation has been performed, the information processing apparatus 200 performs, in step S751, another processing instructed and operated.

(Display Frame Control)

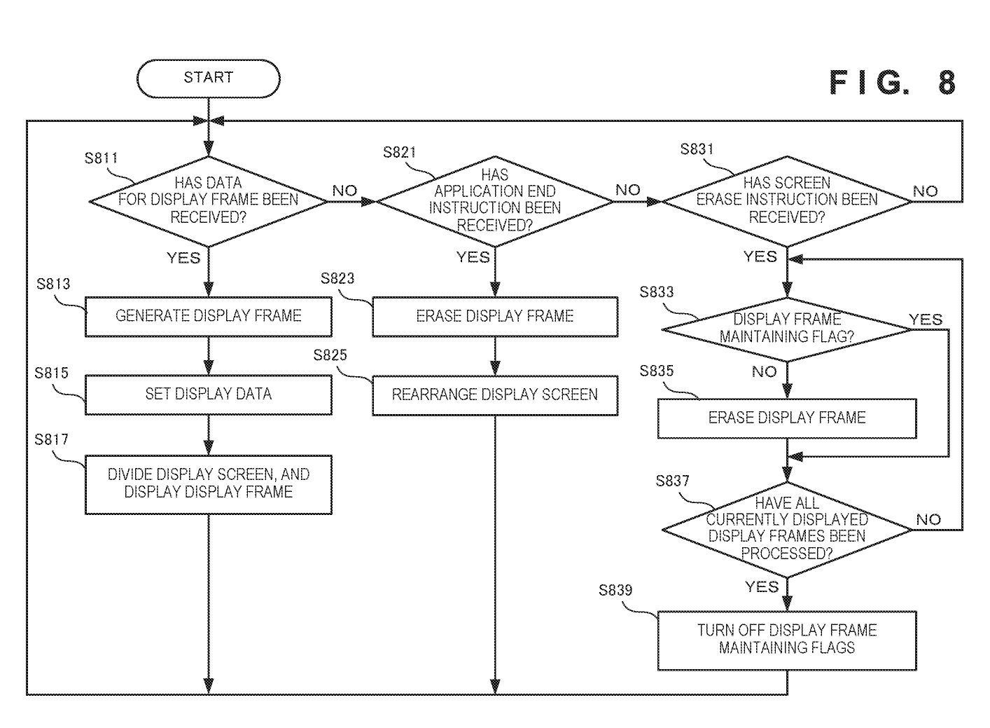

FIG. 8 is a flowchart illustrating a display frame control procedure according to this embodiment.

In step S811, the information processing apparatus 200 determines whether data for a display frame has been received by the processing in step S717 of FIG. 7. If data for a display frame has been received, the information processing apparatus 200 generates a display frame in step S813. Next, in step S815, the information processing apparatus 200 sets the received display data in the generated display frame. In step S817, the information processing apparatus 200 divides the display screen, and displays the display data of the display frame. Note that the procedure of dividing the display screen has been explained in steps S813 to S817 above. If divided screens are generated by a plurality of display frames, the display data is assigned to a display frame in correspondence with the application, and generation of a display frame in step S813 is unnecessary.

If no data for a display frame has been received, the information processing apparatus 200 determines in step S821 whether an application end instruction has been received that had been instructed in step S723 of FIG. 7. If the application end instruction has been received, the information processing apparatus 200 erases, in step S823, the display frame in which the display data is displayed. In step S825, the information processing apparatus 200 rearranges the display screen. Note that if the divided screens are preset, as described above, data are rearranged in the opened display frames, and erase of the display frame in step S823 is unnecessary.

If neither data for a display frame nor an application end instruction has been received, the information processing apparatus 200 determines in step S831 whether a screen erase instruction has been received by the processing in step S743 of FIG. 7. If the screen erase instruction has been received, the information processing apparatus 200 determines, for one of the displayed display frames, in step S833 whether the display frame maintaining flag is “1”. If the display frame maintaining flag is “0”, the information processing apparatus 200 erases the display frame in step S835. On the other hand, if the display frame maintaining flag is “1”, the information processing apparatus 200 advances to step S837. In step S837, the information processing apparatus 200 determines whether the processing is complete for all the currently displayed display frames. If the processing is not complete, the information processing apparatus 200 returns to step S833, and repeats the processing for all the displayed display frames.

Upon completion of the processing for all the display frames, the information processing apparatus 200 turns off the display frame maintaining flags in step S839, thereby ending screen erase while the screen for which the screen maintaining operation has been performed is maintained.

According to this embodiment, a screen erase operation makes it possible to maintain display of a necessary window by a screen maintaining touch and erase another window on which no screen maintaining touch has been performed.

### Third Embodiment

An information processing apparatus according to the third embodiment of the present invention will be described next. The information processing apparatus according to this embodiment is different from that according to the second embodiment in that a window for which a display maintaining operation has been performed is displayed as if it were fixed by a mark (pin). The remaining components and operations are the same as those in the second embodiment. Hence, the same reference numerals denote the same components and operations, and a detailed description thereof will be omitted.

<<Screen Maintenance Operation>>

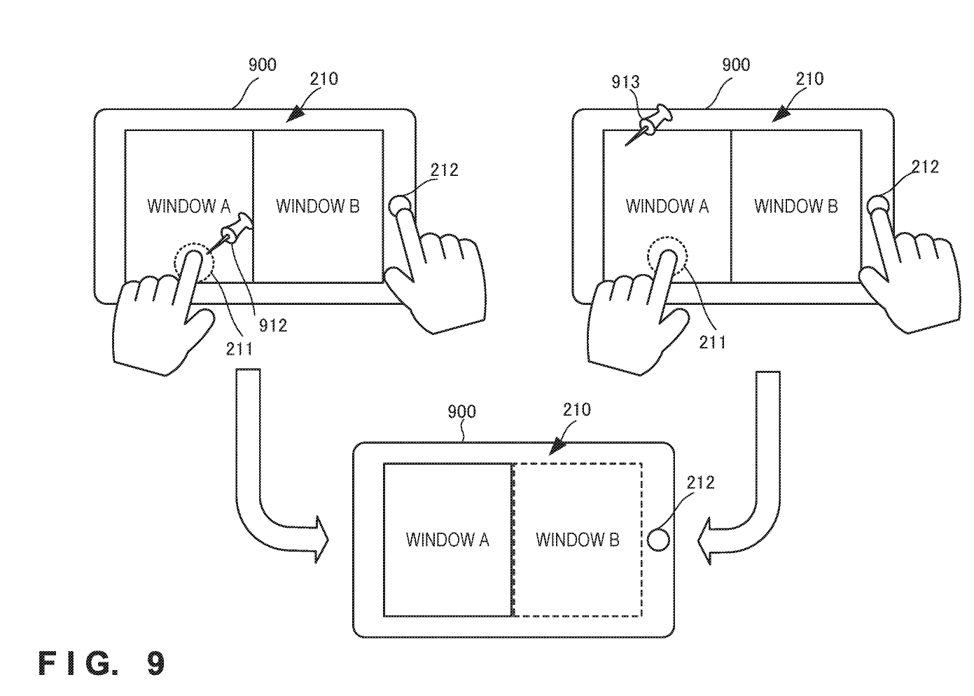

FIG. 9 is a view showing a screen maintaining operation of an information processing apparatus 900 according to this embodiment. FIG. 9 shows a screen maintaining touch on a divided screen, pin display, and a screen erase operation→screen maintaining and screen erase.

Windows A and B are divisionally displayed on a display screen 210 of the information processing apparatus 900. In a state in which the user performs a screen maintaining touch 211 on window A, a pin 912 or 913 representing that window A is not to be erased is displayed in the region of window A.

Upon the pressing of a home button 212 in the state in which the pin is displayed, the display of window A is maintained and window B is erased in response to the screen maintaining touch 211 and the pressing of the home button 212. Note that the operation of an application which has opened window B is continued.

(Display Frame Information)

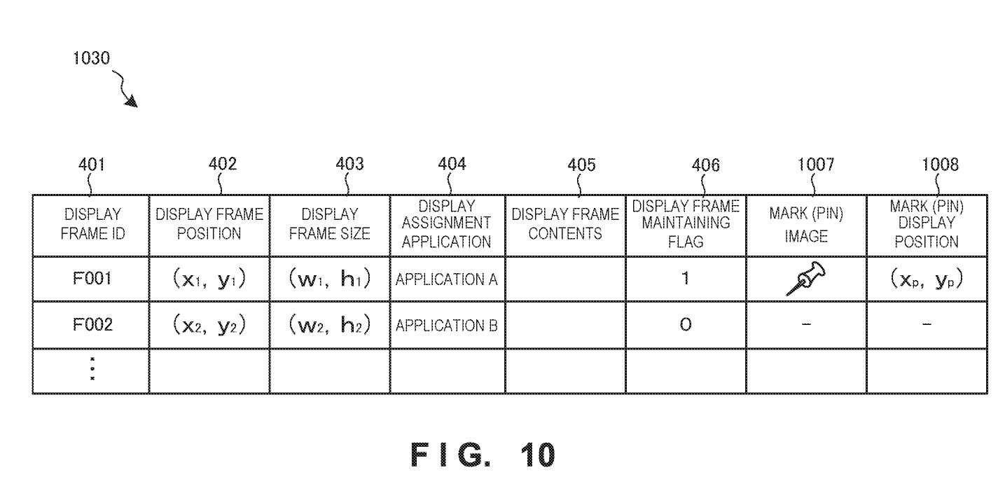

FIG. 10 is a table showing the structure of display frame information 1030 according to this embodiment. The display frame information 1030 is used in a display controller 303 instead of the display frame information 330. Note that in FIG. 10, the same reference numerals as those in FIG. 4 denote the same components, and a description thereof will be omitted.

The display frame information 1030 also stores a mark (pin) image 1007 and a mark (pin) display position 1008. If a display frame maintaining flag is “1”, the mark (pin) image 1007 stores an image to be superimposed and displayed. The mark (pin) display position 1008 stores a position in the window, at which the mark (pin) image 1007 is superimposed and displayed.

<<Processing Procedure of Information Processing Apparatus>>

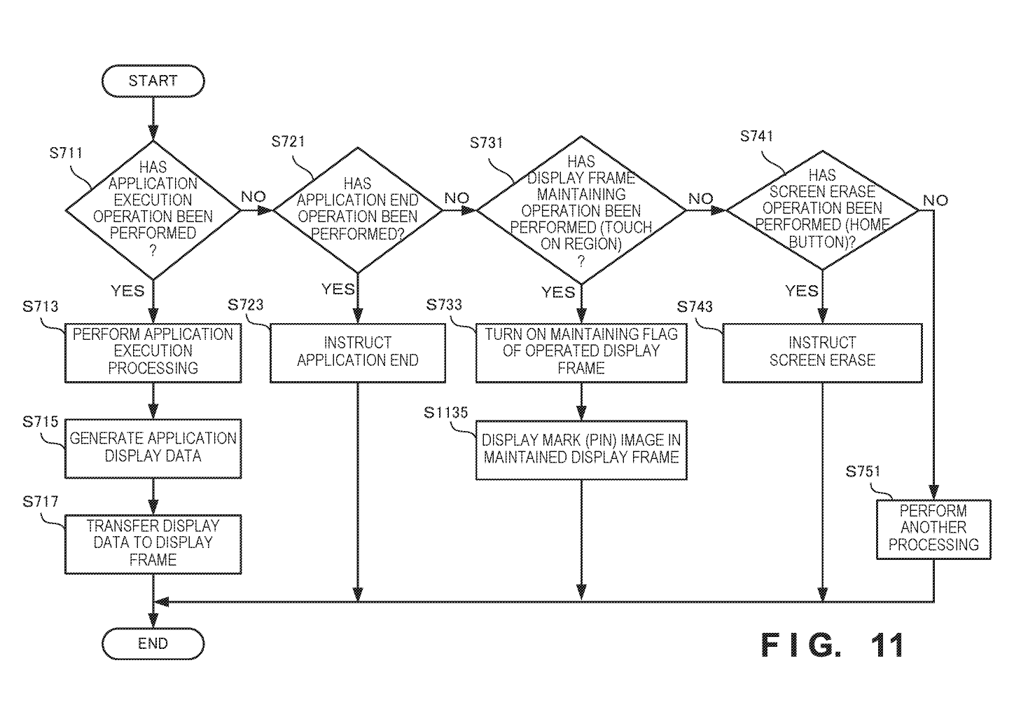

FIG. 11 is a flowchart illustrating the processing procedure of the information processing apparatus 900 according to this embodiment. This flowchart is executed by a CPU 610 of FIG. 6 using a RAM 640, thereby implementing the functional components of FIG. 3. Note that in FIG. 11, the same step numbers as those in FIG. 7 denote the same steps, and a description thereof will be omitted.

If it is determined in step S731 that a screen maintaining operation has been performed, in step S733 the information processing apparatus 900 sends a notification of a display frame for which the screen maintaining operation has been performed, and turns on a display frame maintaining flag. In step S1135, the information processing apparatus 900 displays a mark (pin) in the display frame undergoing screen maintaining, thereby visualizing screen maintaining processing and its target window.

According to this embodiment, since a mark is displayed in a window whose display is maintained by a screen maintaining touch, it is possible to readily discriminate the window from another window on which no screen maintaining touch has been performed.

### Fourth Embodiment

An information processing apparatus according to the fourth embodiment of the present invention will be described next. The information processing apparatus according to this embodiment is different from those according to the second and third embodiments in that a window for which a display maintaining operation has been performed is colored and displayed. The remaining components and operations are the same as those in the second and third embodiments. Hence, the same reference numerals denote the same components and operations, and a detailed description thereof will be omitted.

<<Screen Maintenance Operation>>

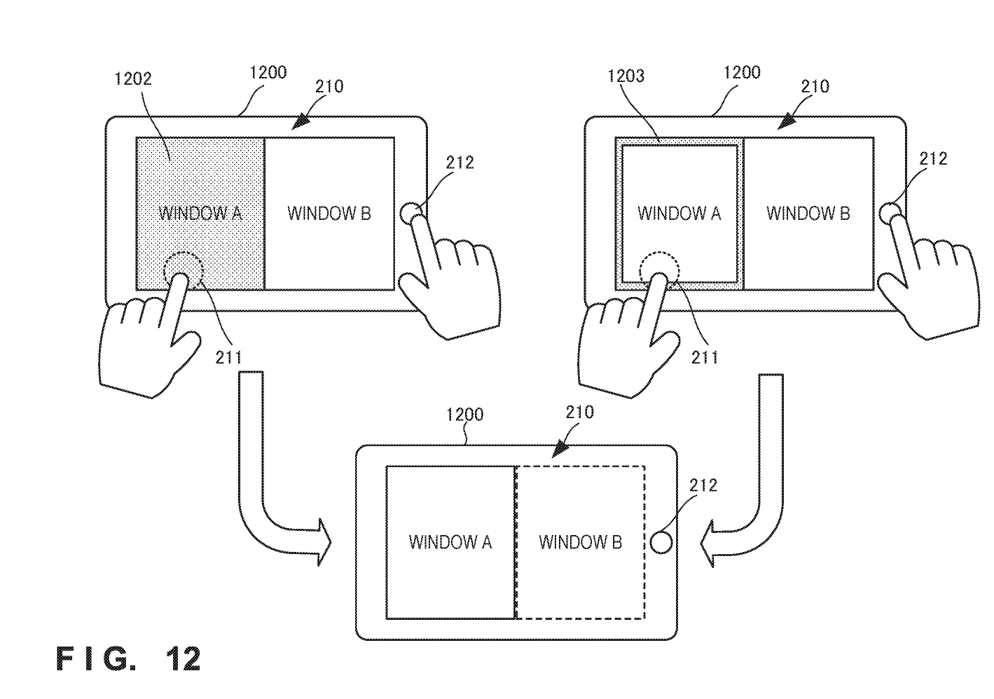

FIG. 12 is a view showing a screen maintaining operation of an information processing apparatus 1200 according to this embodiment. FIG. 12 shows a screen maintaining touch on a divided screen, colored display, and a screen erase operation→screen maintaining and screen erase.

Windows A and B are divisionally displayed on a display screen 210 of the information processing apparatus 1200. In a state in which the user performs a screen maintaining touch 211 on window A, window color display 1202 or edge color display 1203 which represents that window A is not to be erased is performed for the region of window A.

Upon the pressing of a home button 212 in the color display state, the display of window A is maintained and window B is erased in response to the screen maintaining touch 211 and the pressing of the home button 212. Note that the operation of an application which has opened window B is continued.

(Display Frame Information)

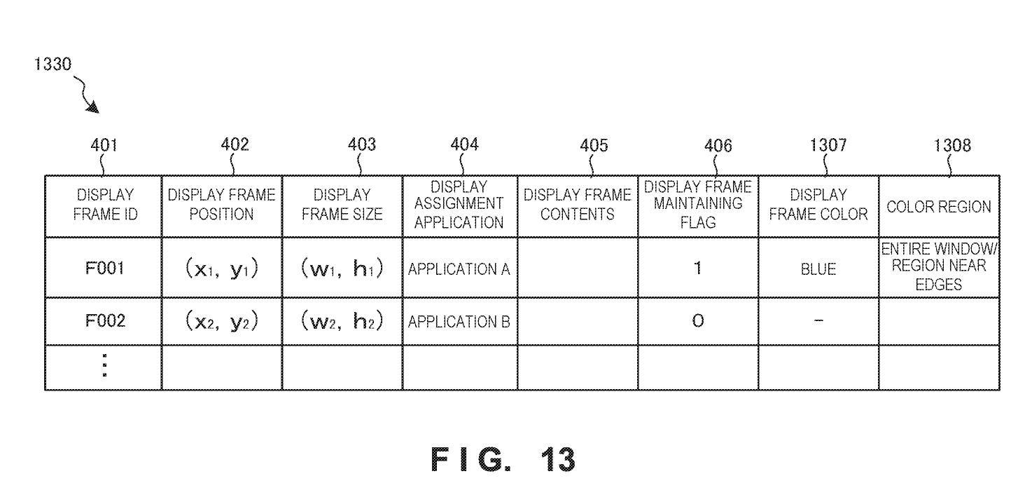

FIG. 13 is a table showing the structure of display frame information 1330 according to this embodiment. The display frame information 1330 is used in a display controller 303 instead of the display frame information 330. Note that in FIG. 13, the same reference numerals as those in FIG. 4 denote the same components, and a description thereof will be omitted.

The display frame information 1330 also stores a display frame color 1307 and a color region 1308. If a display frame maintaining flag is “1”, the display frame color 1307 stores a color to be applied to a window undergoing screen maintaining. The color region 1308 stores data indicating whether the region applied with the display frame color 1307 is an entire window (1202) or a region near the edges (1203).

<<Processing Procedure of Information Processing Apparatus>>

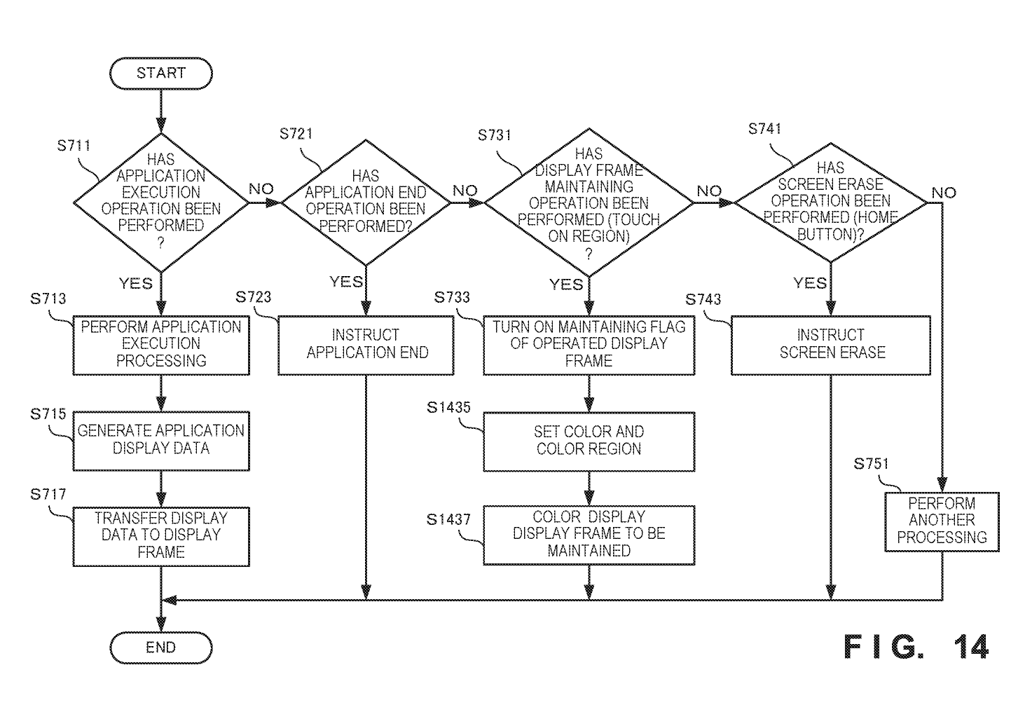

FIG. 14 is a flowchart illustrating the processing procedure of the information processing apparatus 1200 according to this embodiment. This flowchart is executed by a CPU 610 of FIG. 6 using a RAM 640, thereby implementing the functional components of FIG. 3. Note that in FIG. 14, the same step numbers as those in FIG. 7 denote the same steps, and a description thereof will be omitted.

If it is determined in step S731 that a screen maintaining operation has been performed, in step S733 the information processing apparatus 1200 sends a notification of a display frame for which the screen maintaining operation has been performed, and turns on a display frame maintaining flag. In step S1435, the information processing apparatus 1200 sets a color of the window to be maintained and a region to be applied with the color. In step S1437, the information processing apparatus 1200 color displays the display frame as the window to be maintained, thereby visualizing screen maintaining processing and its target window.

According to this embodiment, since a window whose display is maintained by a screen maintaining touch is colored and displayed, it is possible to readily discriminate the window from another window on which no screen maintaining touch has been performed.

### Fifth Embodiment

An information processing apparatus according to the fifth embodiment of the present invention will be described next. The information processing apparatus according to this embodiment is different from those according to the second to fourth embodiments in that a window for which a display maintaining operation has been performed is displayed as if it were recessed. The remaining components and operations are the same as those in the second to fourth embodiments. Hence, the same reference numerals denote the same components and operations, and a detailed description thereof will be omitted.

<<Screen Maintenance Operation>>

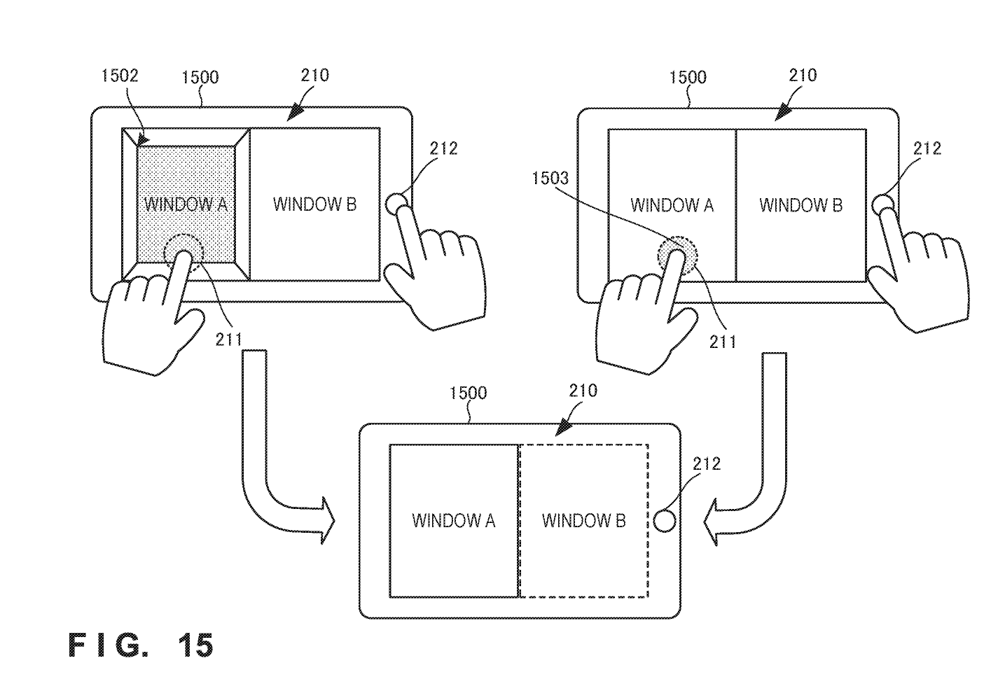

FIG. 15 is a view showing a screen maintaining operation of an information processing apparatus 1500 according to this embodiment. FIG. 15 shows a screen maintaining touch on a divided screen, recessed display, and a screen erase operation→screen maintaining and screen erase.

Windows A and B are divisionally displayed on a display screen 210 of the information processing apparatus 1500. In a state in which the user performs a screen maintaining touch 211 on window A, display 1502 in which the entire window is recessed to indicate that window A is not to be erased or display 1503 in which a screen maintaining operation region is recessed is performed for the region of window A.

Upon the pressing of a home button 212 in the state in which recessed display is performed, the display of window A is maintained and window B is erased in response to the screen maintaining touch 211 and the pressing of the home button 212. Note that the operation of an application which has opened window B is continued.

(Display Frame Information)

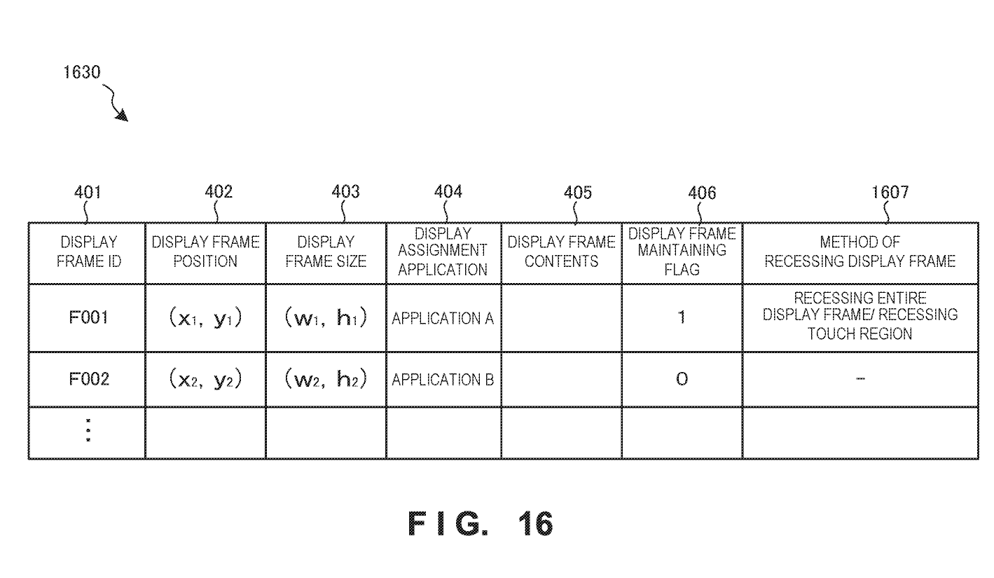

FIG. 16 is a table showing the structure of display frame information 1630 according to this embodiment. The display frame information 1630 is used in a display controller 303 instead of the display frame information 330. Note that in FIG. 16, the same reference numerals as those in FIG. 4 denote the same components, and a description thereof will be omitted.

The display frame information 1630 also stores a method 1607 of recessing a display frame. If a display frame maintaining flag is “1”, the method 1607 stores a method of displaying a window to be maintained as if the display frame was recessed. For example, a display method (as shown by 1502) in which the entire window is recessed and a display method (as shown by 1503) in which the operation region of the screen to be maintained is recessed are stored. Note that the recessed display method is not limited to them. For example, gradations in color or density are included.

<<Processing Procedure of Information Processing Apparatus>>

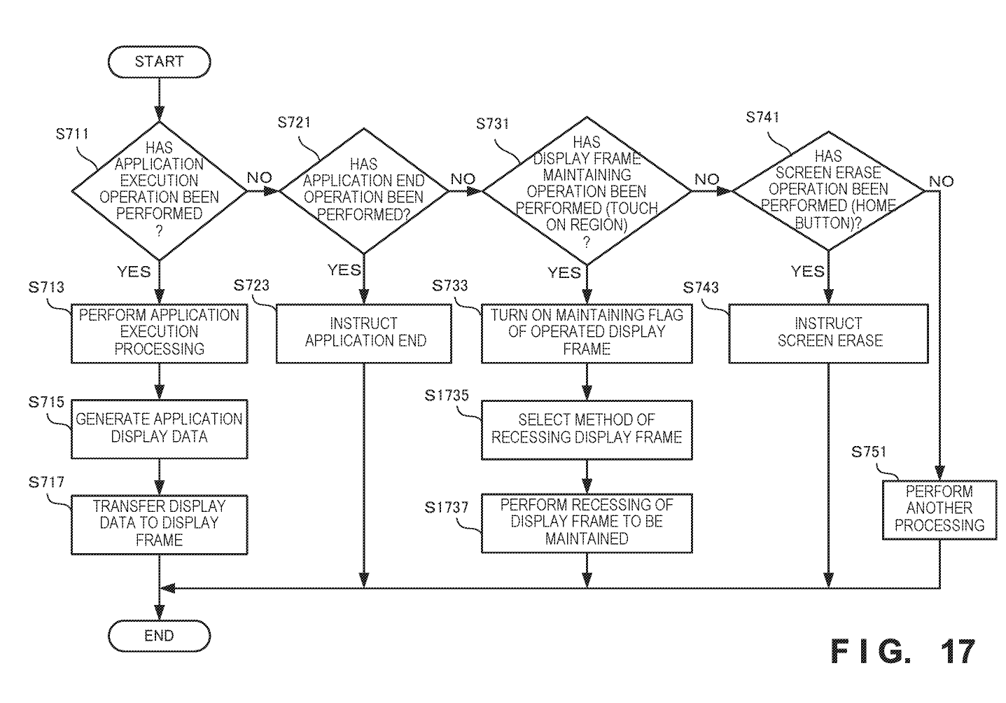

FIG. 17 is a flowchart illustrating the processing procedure of the information processing apparatus 1500 according to this embodiment. This flowchart is executed by a CPU 610 of FIG. 6 using a RAM 640, thereby implementing the functional components of FIG. 3. Note that in FIG. 17, the same step numbers as those in FIG. 7 denote the same steps, and a description thereof will be omitted.

If it is determined in step S731 that a screen maintaining operation has been performed, in step S733 the information processing apparatus 1500 sends a notification of a display frame for which the screen maintaining operation has been performed, and turns on a display frame maintaining flag. In step S1735, the information processing apparatus 1500 selects the recessed display method. In step S1737, the information processing apparatus 1500 performs recessed display of the window undergoing screen maintaining, thereby visualizing screen maintaining processing and its target window.

According to this embodiment, since a window whose display is maintained by a screen maintaining touch is displayed as if it were recessed, it is possible to readily discriminate the window from another window on which no screen maintaining touch has been performed.

### Sixth Embodiment

An information processing apparatus according to the sixth embodiment of the present invention will be described next. The information processing apparatus according to this embodiment is different from those according to the second to fifth embodiments in that a screen maintaining touch is determined not in a region of a window but on an edge or frame of the window. The remaining components and operations are the same as those in the second to fifth embodiments. Hence, the same reference numerals denote the same components and operations, and a detailed description thereof will be omitted.

<<Screen Maintenance Operation>>

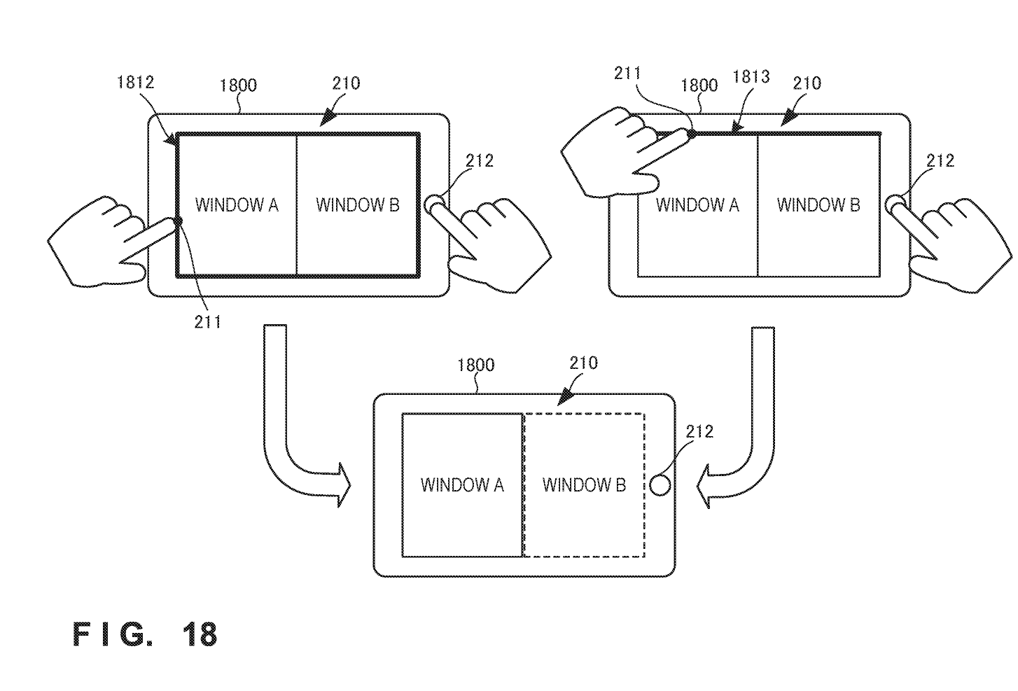

FIG. 18 is a view showing a screen maintaining operation of an information processing apparatus 1800 according to this embodiment. FIG. 18 shows a screen maintaining touch position on a divided screen and a screen erase operation→screen maintaining and screen erase.

Windows A and B are divisionally displayed on a display screen 210 of the information processing apparatus 1800. In a state in which the user performs a screen maintaining touch 211 on a three-way edge 1812 of window A or a state in which the user performs the screen maintaining touch 211 on an upper edge 1813 as part of the edge of window A, he/she presses a home button 212. In response to the screen maintaining touch 211 and the pressing of the home button 212, the display of window A is maintained and window B is erased. Note that the operation of an application which has opened window B is continued. In this state, the three-way edge 1812 or the upper edge 1813 may be visualized by thick lines or coloring.

(Maintenance Determination Table)

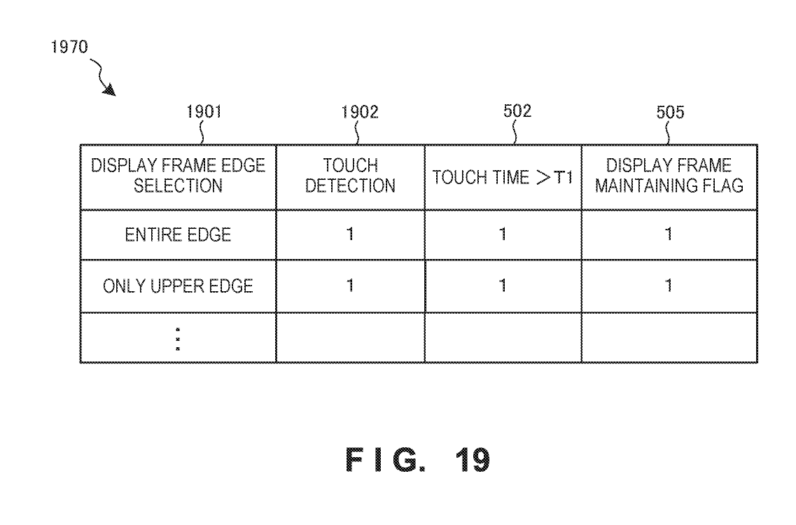

FIG. 19 is a table showing the structure of a maintaining determination table 1970 according to this embodiment. The maintaining determination table 1970 is used in a display frame maintaining determiner 307 instead of the maintaining determination table 370. Note that in FIG. 19, the same reference numerals as those in FIG. 5 denote the same components, and a description thereof will be omitted.

The maintaining determination table 1970 stores display frame edge selection 1901, touch detection 1902 on an edge, and data 502 indicating whether a touch time exceeds a threshold T1. If a touch on a selected edge is detected and a touch time exceeds the threshold T1, the touch is determined as a screen maintaining touch operation. The maintaining determination table 1970 stores a display frame maintaining flag 505 as a screen maintaining determination result.

<<Processing Procedure of Information Processing Apparatus>>

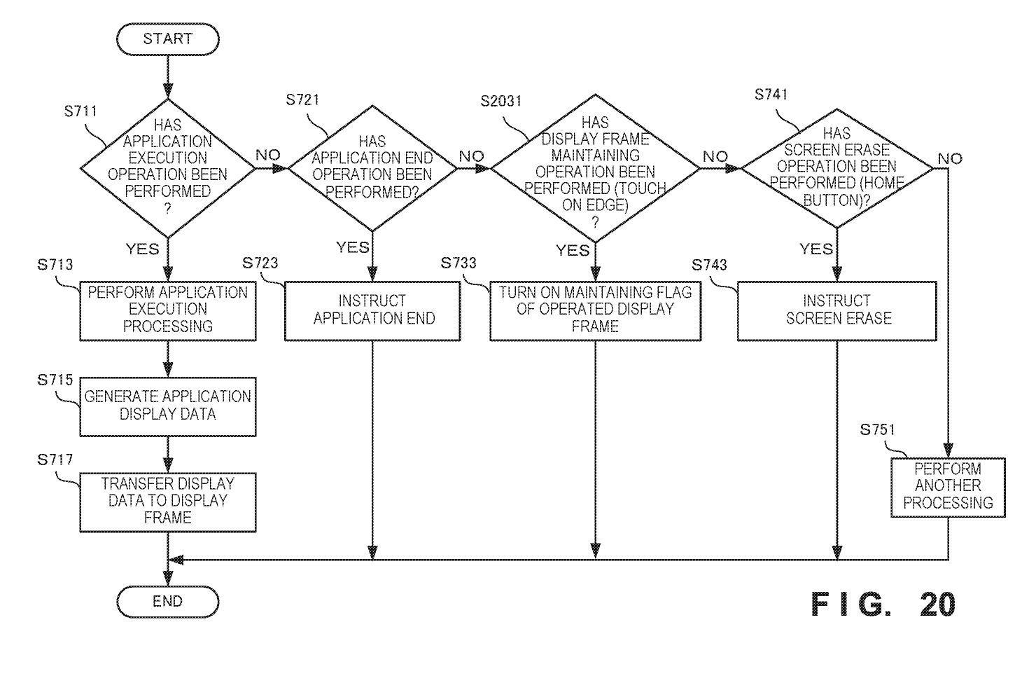

FIG. 20 is a flowchart illustrating the processing procedure of the information processing apparatus 1800 according to this embodiment. This flowchart is executed by a CPU 610 of FIG. 6 using a RAM 640, thereby implementing the functional components of FIG. 3. Note that in FIG. 20, the same step numbers as those in FIG. 7 denote the same steps, and a description thereof will be omitted.

In step S2031, the information processing apparatus 1800 determines, as a display frame maintaining operation, a touch on a selected edge of a window undergoing screen maintaining. If it is determined that the screen maintaining operation has been performed, in step S733 the information processing apparatus sends a notification of the display frame for which the screen maintaining operation has been performed, and turns on the display frame maintaining flag.

According to this embodiment, since a screen maintaining touch is performed on an edge of a window, it is possible to readily avoid confusion with a touch operation on a software button or the like in the window.

### Seventh Embodiment

Information processing according to the seventh embodiment of the present invention will be described next. An information processing apparatus according to this embodiment is different from those according to the second to sixth embodiments in that a blank after a window is erased is used. The remaining components and operations are the same as those in the second to sixth embodiments. Hence, the same reference numerals denote the same components and operations, and a detailed description thereof will be omitted.

<<Screen Maintenance Operation>>

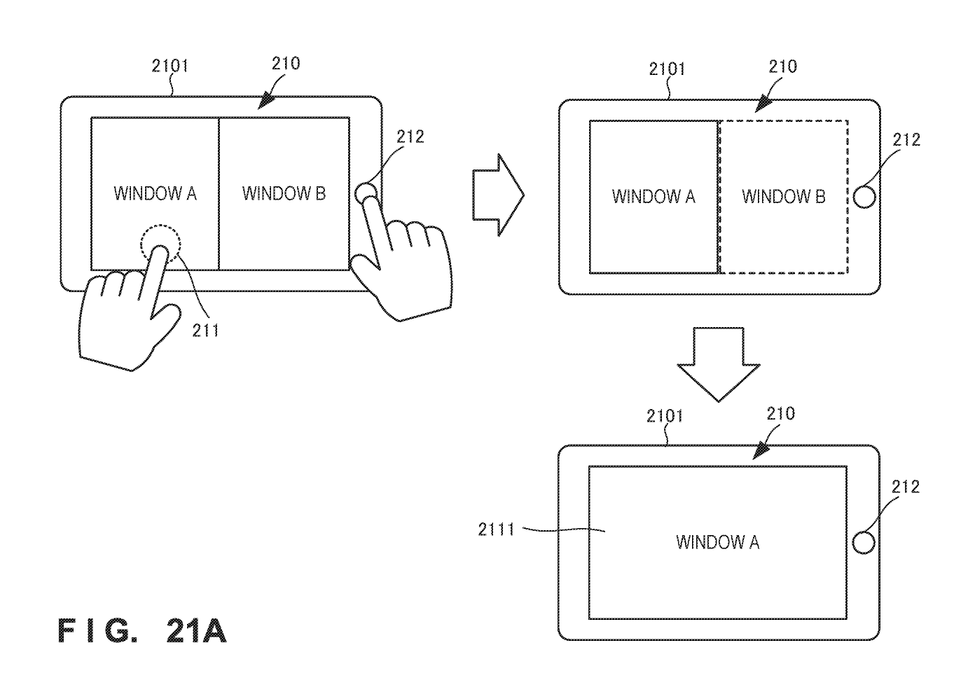

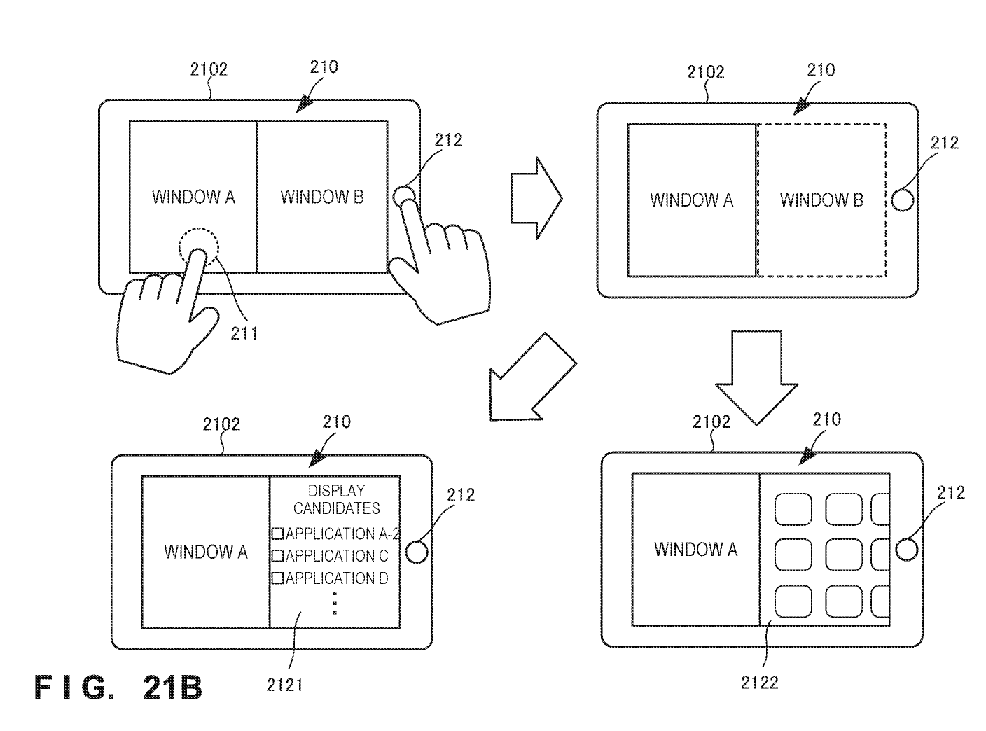

FIG. 21A is a view showing a screen maintaining operation of an information processing apparatus 2101 according to this embodiment. Note that in FIG. 21A, the same reference numerals as those in FIG. 2 denote the same components, and a description thereof will be omitted.

Referring to FIG. 21A, after window B is erased by a screen maintaining operation of window A, window A is displayed on an entire display screen 2111. Display on the entire display screen 2111 may be performed by enlarging window A or displaying a hidden portion of window A.

FIG. 21B is a view showing another screen maintaining operation of an information processing apparatus 2102 according to this embodiment. Note that in FIG. 21B, the same reference numerals as those in FIG. 2 denote the same components, and a description thereof will be omitted.

Referring to FIG. 21B, after window B is erased by a screen maintaining operation of window A, display candidates 2121 or a home screen 2122 is displayed in the blank region. Note that display contents in the blank region are not limited to them. A menu or information related to window A undergoing screen maintaining may be displayed.

(Display Frame Information)

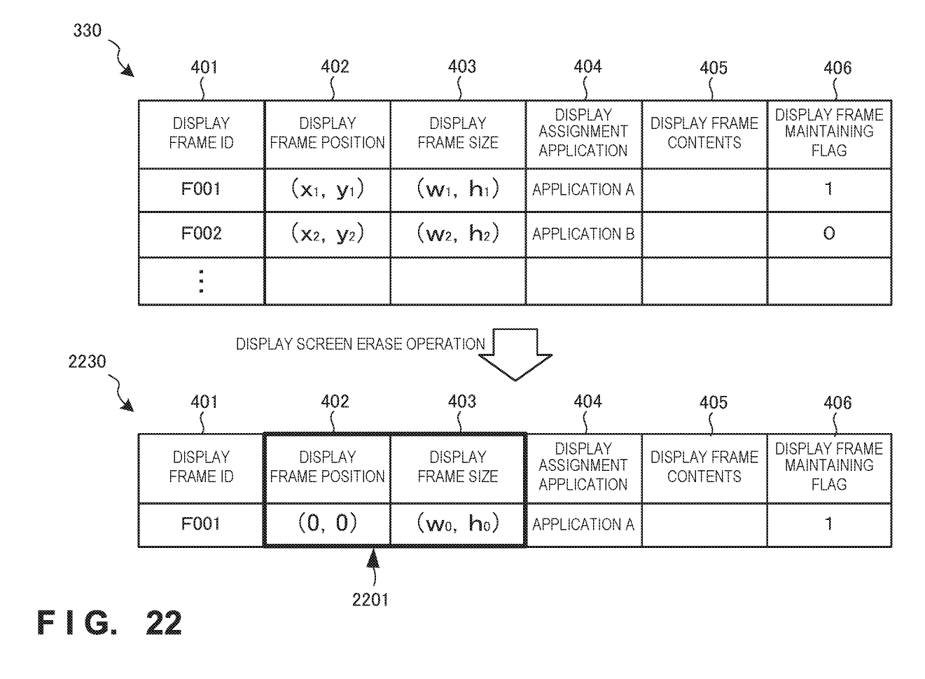

FIG. 22 is a view showing the structure of display frame information 2230 according to this embodiment. The display frame information 2230 has a structure corresponding to display on the entire screen of window A shown in FIG. 21A. Note that in FIG. 22, the same reference numerals as those in FIG. 4 denote the same components, and a description thereof will be omitted.

Display frame information 330 before a screen maintaining operation has a structure shown in the upper part of FIG. 22. If transition of a screen maintaining operation→a screen erase operation (erase of window B)→display of the entire screen of window A is performed, a display frame position 402 and a display frame size to which application A is assigned are changed to entire screen values 2201, as shown in the lower part of FIG. 22.

Note that display frame information corresponding to FIG. 21B has a structure in which a screen of other application candidates or a home screen is assigned to the display frame region of the erased window.

According to this embodiment, it is possible to provide a service to the user using the region of an erased window.

### Eighth Embodiment

An information processing apparatus according to the eighth embodiment of the present invention will be described next. The information processing apparatus according to this embodiment is different from those according to the second to seventh embodiments in that processing is performed for an operation in three or more divided screens without limitation to two divided screens or an operation in a superimposed and displayed window. The remaining components and operations are the same as those in the second to sixth embodiments. Hence, the same reference numerals denote the same components and operations, and a detailed description thereof will be omitted.

<<Screen Maintenance Operation>>

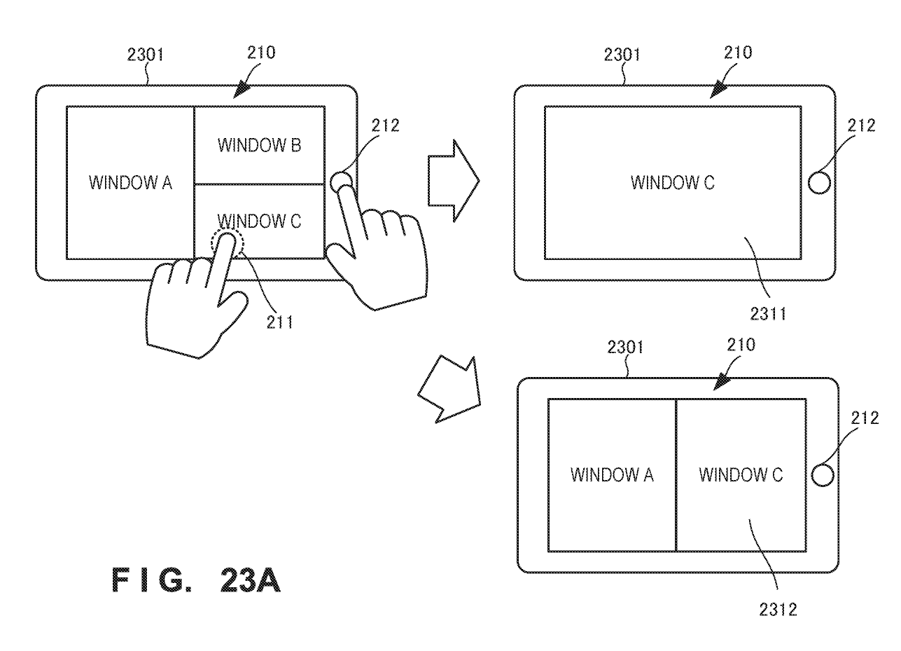

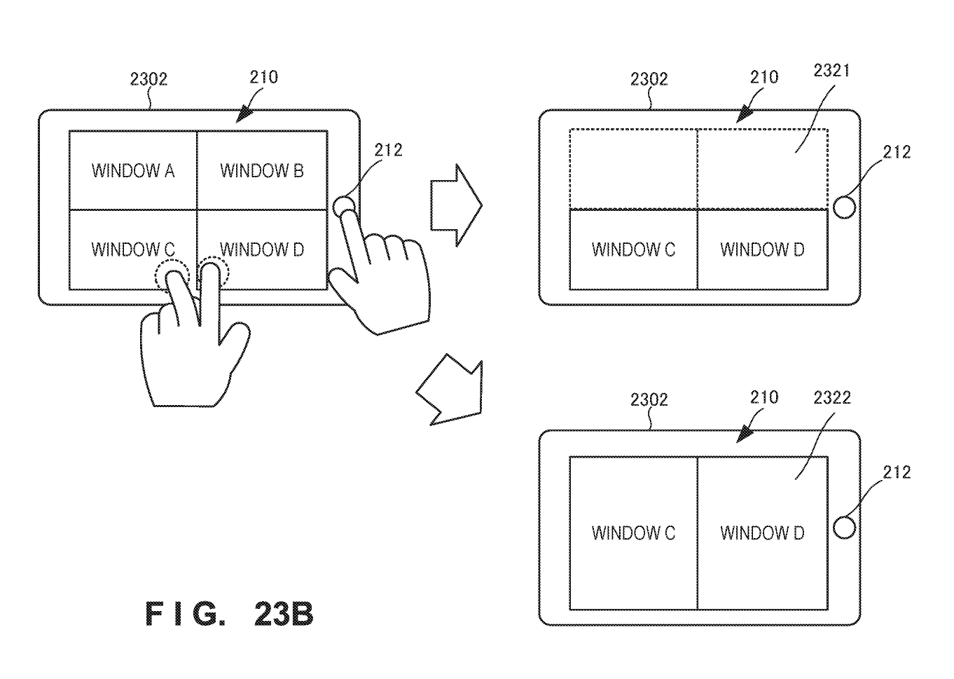

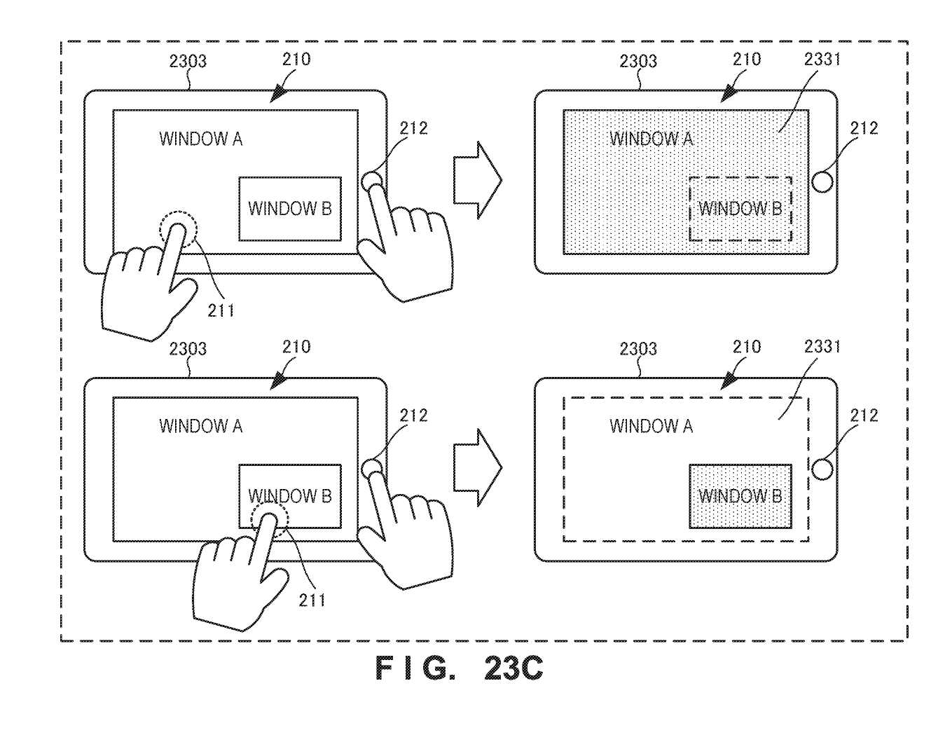

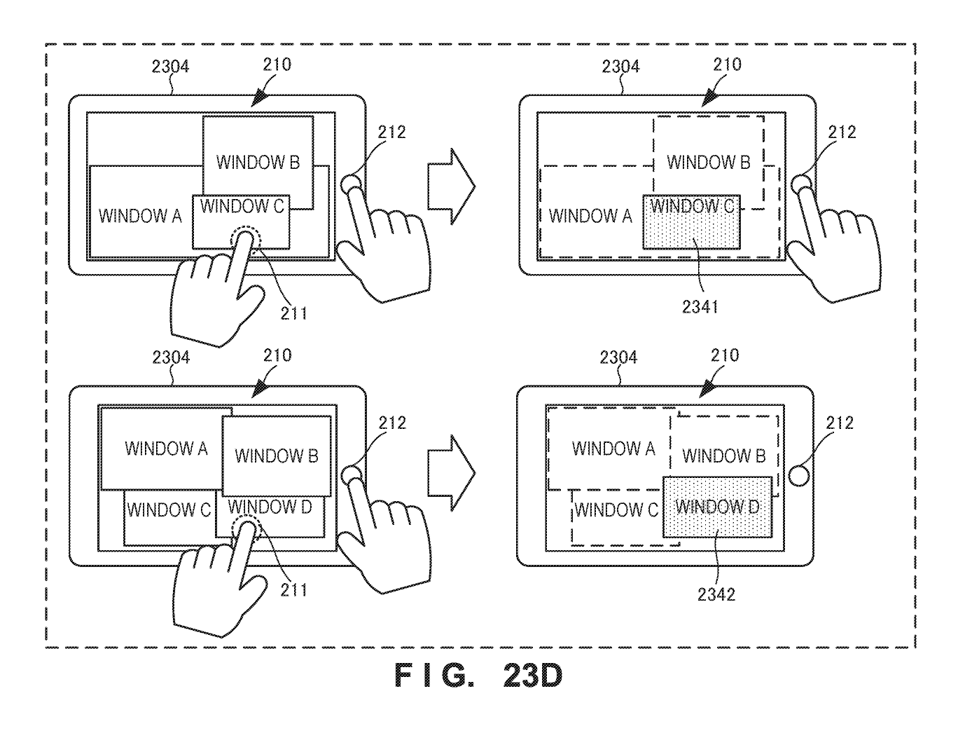

Examples of screen maintaining operations and screen maintaining results in various screen displays which have not been described in the above embodiments will be explained below with reference to FIGS. 23A to 25. By combining the examples, more various screen maintaining operations can be performed.

(3-Division Screen)

FIG. 23A is a view showing a screen maintaining operation for the 3-division screen of an information processing apparatus 2301 according to this embodiment.

FIG. 23A shows an example in which window C of the 3-division screen is selected as a maintaining screen. As an example, window C as a maintaining screen is displayed on the entire screen. As another example, window B is erased and window C as a maintaining screen is extended in the vertical direction and displayed.

(4-Division Screen) FIG. 23B is a view showing a screen maintaining operation for the 4-division screen of an information processing apparatus 2302 according to this embodiment.

FIG. 23B shows an example in which windows C and D of the 4-division screen are selected as maintaining screens. As an example, windows C and D as maintaining screens are maintained and windows A and B are erased. As another example, windows C and D are extended and displayed in the regions of erased windows A and B.

(Superimposed Screen)

FIG. 23C is a view showing a screen maintaining operation of a superimposed screen of an information processing apparatus 2303 according to this embodiment.

Referring to FIG. 23C, window B is forcibly displayed on window A for playing back music or a moving image. Even on the superimposed screen, if a screen maintaining operation is performed in the region of window A and a screen erase operation is performed, window A undergoes screen maintaining and window B is erased. Conversely, if a screen maintaining operation is performed in the region of window B and a screen erase operation is performed, window B undergoes screen maintaining and window A is erased.

(Superimposed Screen)

FIG. 23D is a view showing another screen maintaining operation of a superimposed screen of an information processing apparatus 2304 according to this embodiment.

Referring to FIG. 23D, three or four windows are superimposed and displayed. If a screen maintaining operation is performed for window C and a screen erase operation is performed, window C is maintained and the remaining windows are erased, regardless of a layer in which window C is displayed.

(Software Key Operation)

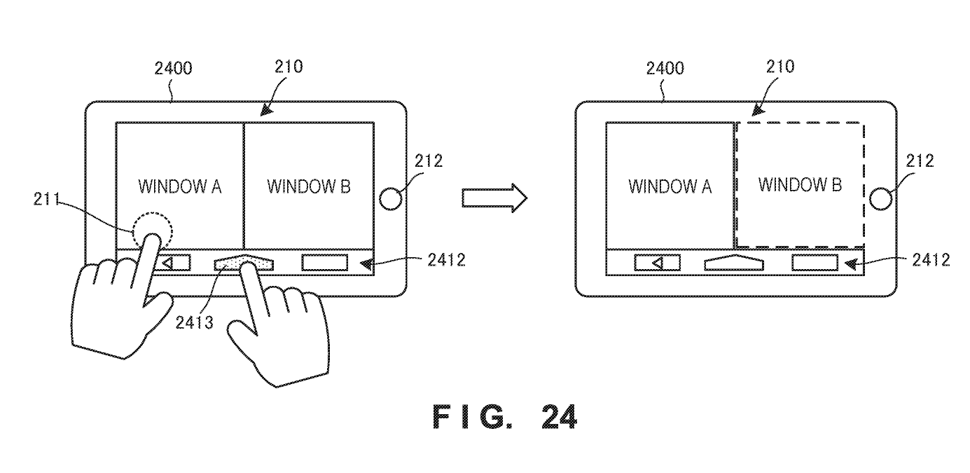

FIG. 24 is a view showing a screen maintaining operation at the time of a software key operation of an information processing apparatus 2400 according to this embodiment.

FIG. 24 shows an example of an operation of replacing the “home button 212” for screen erase in the above embodiments by a “software key 2413” of a software key region 2412.

(Rotation Operation)

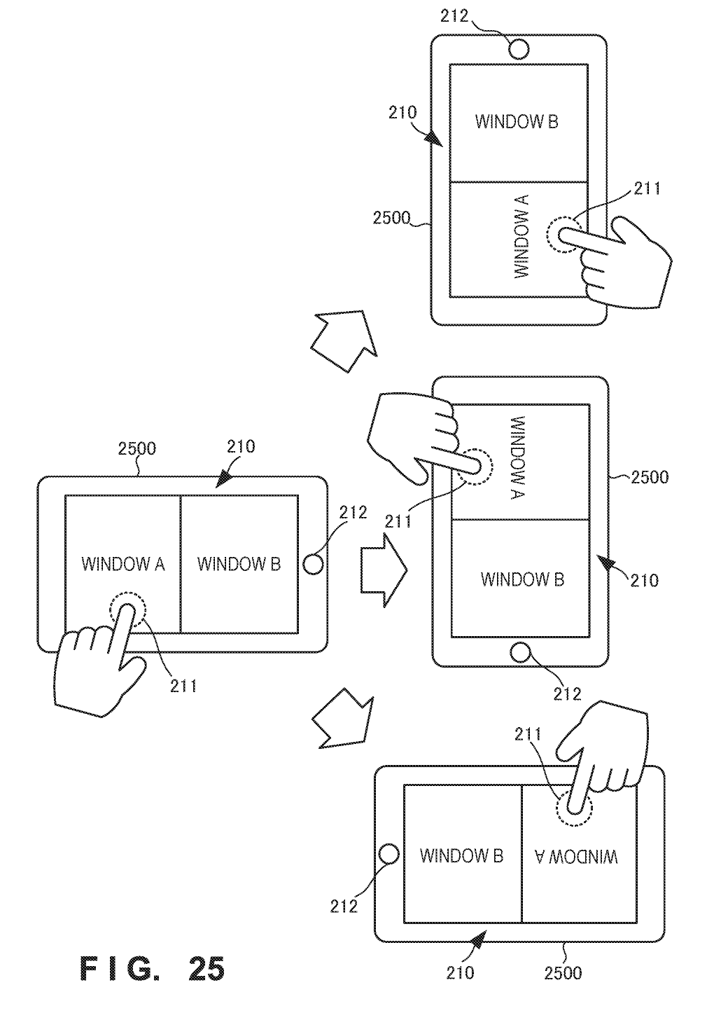

FIG. 25 is a view showing a screen maintaining operation at the time of a rotation operation of an information processing apparatus 2500 according to this embodiment.

FIG. 25 shows a state in which a screen maintaining operation is performed for window A to rotate the information processing apparatus 2500. While the display direction of window A is maintained with respect to the information processing apparatus 2500, the display direction of window B is rotated to be upside down based on geomagnetism.

According to this embodiment, without limitation to two divided screens, it is possible to maintain display of a necessary window by a screen maintaining touch even by a screen erase operation, and operate another window on which no screen maintaining touch has been performed.

### Ninth Embodiment

An information processing apparatus according to the ninth embodiment of the present invention will be described next. The information processing apparatus according to this embodiment is different from those according to the second to eighth embodiments in that an operation is not window erase. The remaining components and operations are the same as those in the second to eighth embodiments. Hence, the same reference numerals denote the same components and operations, and a detailed description thereof will be omitted.

<<Screen Maintenance Operation>>

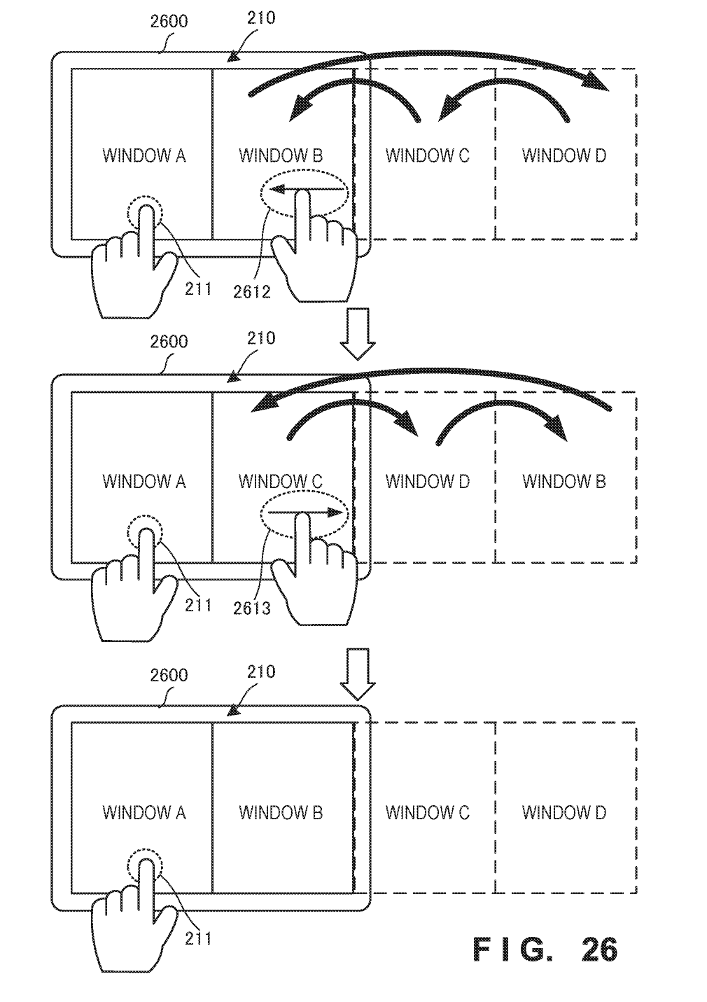

FIG. 26 is a view showing a screen maintaining operation of an information processing apparatus 2600 according to this embodiment. FIG. 26 shows, from above, a screen maintaining touch on a divided screen and a screen rotation operation→screen maintaining after the first rotation operation and a screen rotation result→screen maintaining after the next rotation operation and a screen rotation result.

Windows A and B are divisionally displayed on a display screen 210 of the information processing apparatus 2600. Furthermore, windows C and D which are hidden without being displayed on the display screen 210 are sequentially indicated by broken lines. In a state in which the user performs a screen maintaining touch 211 on window A, he/she performs an operation of a screen rotation instruction 2612 on window B (see the upper view).

In response to the screen maintaining touch 211 and the screen rotation instruction 2612, the display of window A is maintained, and windows B to D are rotated in directions indicated by arrows. As a result, window C appears on the display screen 210, and window B moves to the end of the hidden windows. An operation of a screen rotation instruction 2613 in the opposite direction is performed in window C (see the central view).

In response to the screen maintaining touch 211 and the screen rotation instruction 2613, the display of window A is maintained, and windows C, D, and B are rotated in directions indicated by arrows. As a result, window B appears on the display screen 210, and windows C and D sequentially shift to be hidden (see the lower view).

As described above, the screen display of window A on which the screen maintaining touch 211 has been performed is maintained regardless of a rotation operation, and remaining windows B to D are operated in response to the rotation operation.

<<Functional Arrangement of Information Processing Apparatus>>

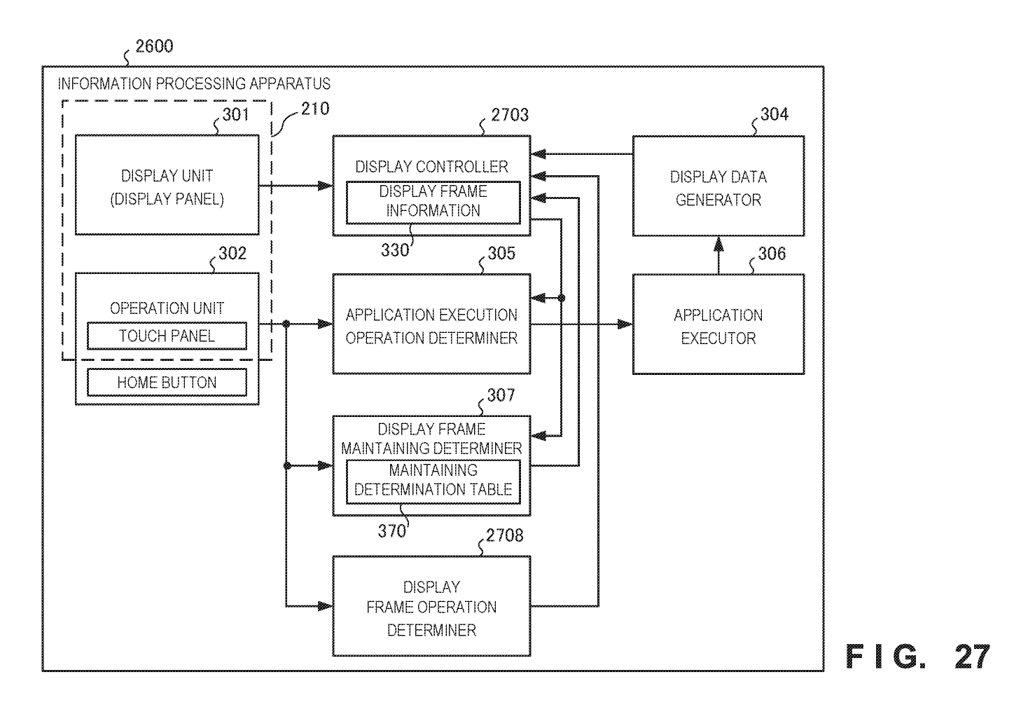

FIG. 27 is a block diagram showing the functional arrangement of the information processing apparatus 2600 according to this embodiment. Note that in FIG. 27, the same reference numerals as those in FIG. 3 denote the same functional components, and a description thereof will be omitted.

The information processing apparatus 2600 includes a display controller 2703 and a display frame operation determiner 2708. The display controller 2703 has display frame information 2730, and assigns, to a display frame, display data generated by executing an application and displays the display data on a display unit 301 so as to implement the operation of this embodiment. The display frame operation determiner 2708 determines whether an operation is an operation on a display frame according to this embodiment, that is, a display frame rotation operation.

Upon receiving, from the display frame operation determiner 2708, a notification that the operation is a display frame rotation operation, the display controller 2703 performs a rotation operation for display frames for which no screen maintaining operation has been performed.

(Display Frame Information)

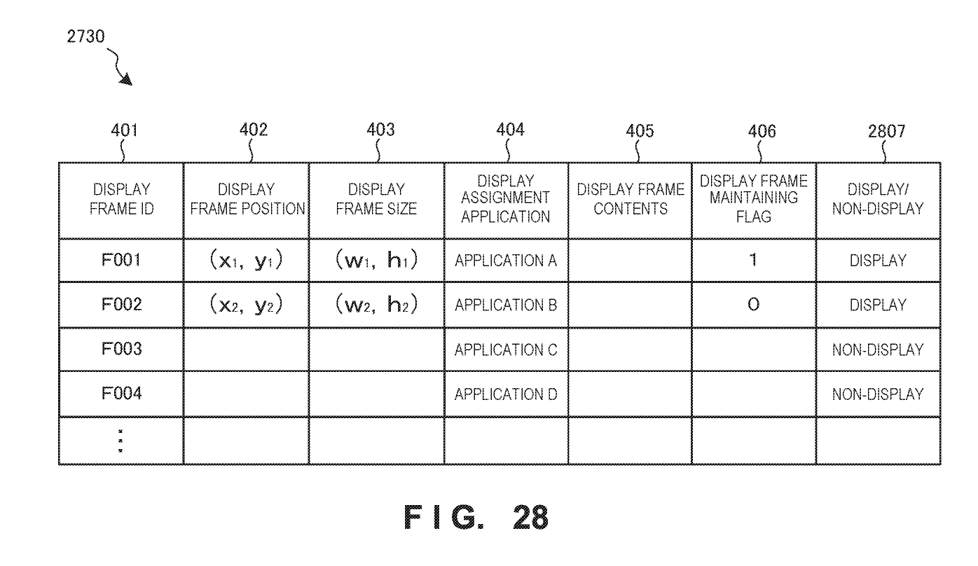

FIG. 28 is a view showing the structure of the display frame information 2730 according to this embodiment. Note that in FIG. 28, the same reference numerals as those in FIG. 4 denote the same components, and a description thereof will be omitted.

Referring to FIG. 28, applications A to D are assigned to four display frames in accordance with FIG. 26. Display/non-display 2807 stores data indicating whether each display frame is displayed on the display screen 210.

In accordance with the operation of FIG. 26, since a display frame maintaining flag 406 of a display frame F001 assigned with display data of application A is “1”, the display of the display frame is maintained regardless of the rotation operation. On the other hand, a display frame F002 assigned with display data of application B is changed to a non-display state. Instead, a display frame F003 assigned with display data of application C is changed to a display state, and a display frame position and a display frame size are set.

Note that in an arrangement in which application A to D are assigned to four display frames whose display/non-display states are fixed, a display assignment application 404 changes, to applications A, C, D, and B, application assignment to the display frames F001 to F003 and a display frame F004.

<<Processing Procedure of Information Processing Apparatus>>

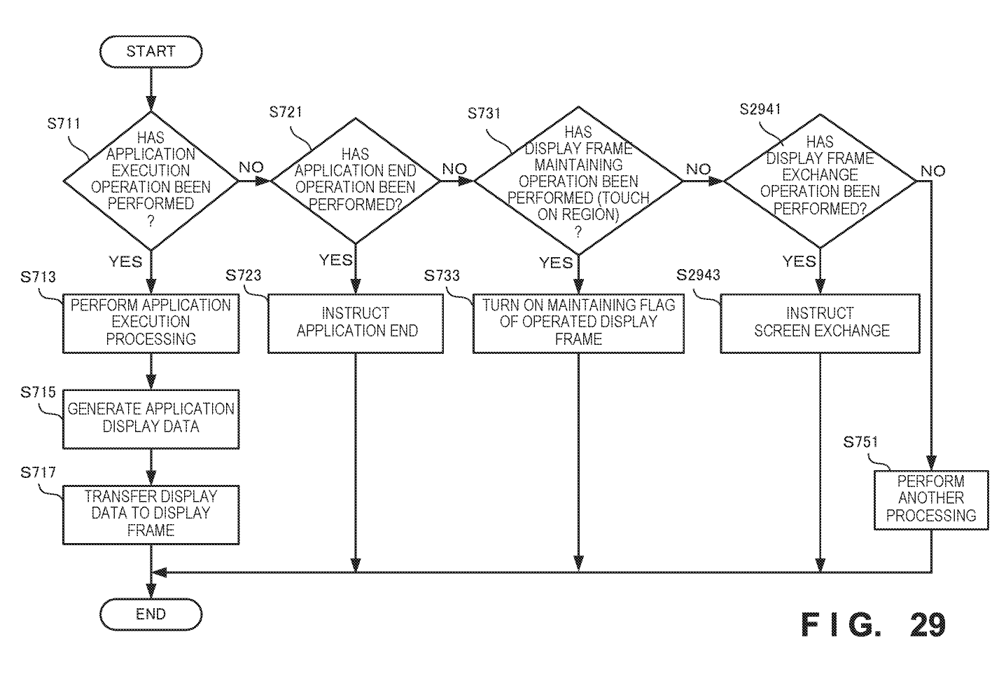

FIG. 29 is a flowchart illustrating the processing procedure of the information processing apparatus 2600 according to this embodiment. This flowchart is executed by a CPU 610 of FIG. 6 using a RAM 640, thereby implementing the functional components of FIG. 27. Note that in FIG. 29, the same step numbers as those in FIG. 7 denote the same steps, and a description thereof will be omitted.

In step S2941, the information processing apparatus 2600 determines whether a display frame exchange operation (rotation operation) has been performed. If a display frame exchange operation (rotation operation) has been performed, the information processing apparatus 2600 instructs screen exchange (screen rotation) in step S2943.

(Display Frame Control)

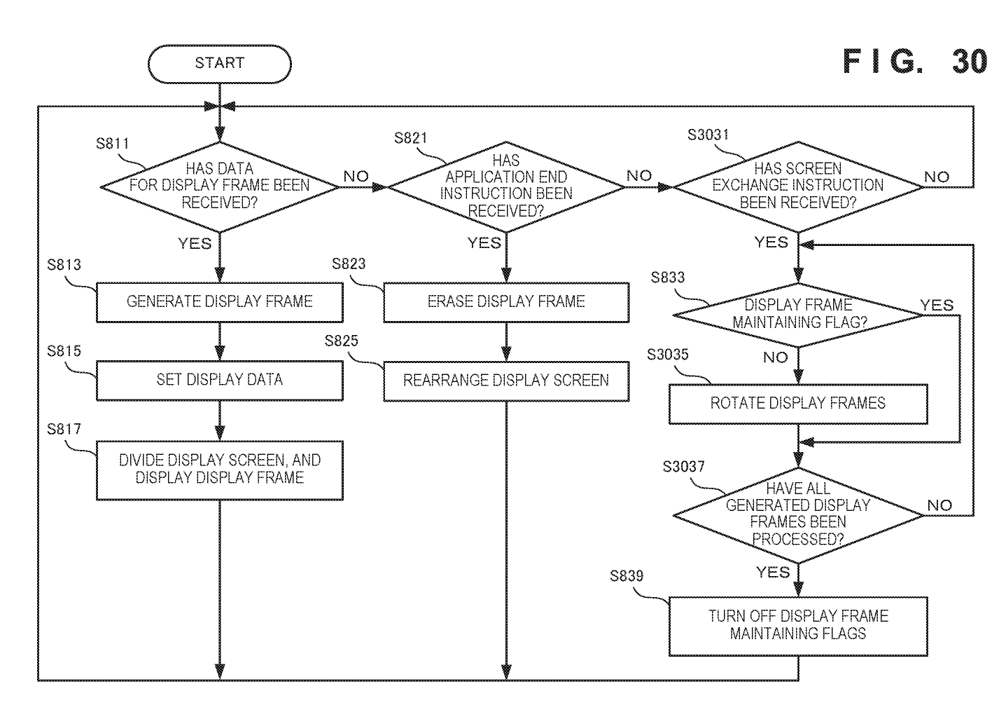

FIG. 30 is a flowchart illustrating a display frame control procedure according to this embodiment. Note that in FIG. 30, the same step numbers as those in FIG. 8 denote the same steps, and a description thereof will be omitted.

In step S3031, the information processing apparatus 2600 determines whether a screen exchange instruction has been received. If a screen exchange instruction has been received, the information processing apparatus 2600 moves to rotate a display frame whose display frame maintaining flag is “0”, while determining in step S833 whether the display frame maintaining flag is “1” or “0”. The information processing apparatus 2600 repeats steps S833, S3035, and S3037 until all the display frames including hidden display frames are processed in step S3037.

According to this embodiment, without limitation to a screen erase operation, it is possible to maintain display of a necessary window by a screen maintaining touch, and operate another window on which no screen maintaining touch has been performed.

### 10th Embodiment

An information processing apparatus according to the 10th embodiment of the present invention will be described next. The information processing apparatus according to this embodiment is different from those according to the second to ninth embodiments in that, for example, a sound output erase operation related to a window is processed without limitation to a window display operation. The remaining components and operations are the same as those in the second to ninth embodiments. Hence, the same reference numerals denote the same components and operations, and a detailed description thereof will be omitted.

<<Sound Maintenance Operation>>

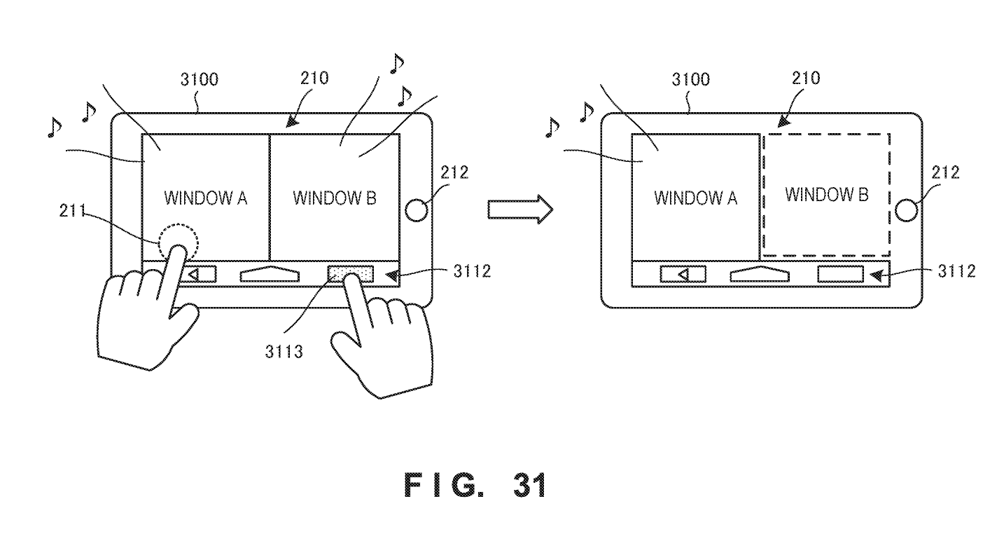

FIG. 31 is a view showing screen maintaining and sound maintaining operations of an information processing apparatus 3100 according to this embodiment. Note that in FIG. 31, the same reference numerals as those in FIG. 2 denote the same components, and a description thereof will be omitted. FIG. 31 shows, from left, a screen maintaining touch on a divided screen and a sound erase operation→screen maintaining, screen erase, and sound erase.

Windows A and B are divisionally displayed on a display screen 210 of the information processing apparatus 3100. Sounds related to windows A and B are output. In a state in which the user performs a screen maintaining touch 211 on window A, he/she touches a sound erase button 3113 of a software key region 3112 (see the left view). In response to the screen maintaining touch 211 and the sound erase button 3113, the display and sound output of window A are maintained and window B is erased and sound erase is performed (the right view). Note that the operation of an application which has opened window B is continued.

FIG. 31 has exemplified the two windows. However, even if, for example, many windows are opened and sounds related to a plurality of windows are overlapped and output, it is possible to select a window of interest and its sound.

According to this embodiment, in addition to a window display operation, the present invention is applicable to other operations such as sound output related to a window, and it is possible to maintain the operation of a necessary window by a screen maintaining touch, and operate another window on which no screen maintaining touch has been performed.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188307 filed on Sep. 16, 2014, which is hereby incorporated by reference herein in its entirety.

1. An information processing apparatus comprising:
a display unit that displays at least two windows;
a determiner that determines a touch for maintaining screen on a display region of the at least two windows; and
a controller that maintains, even when an operation for the at least two windows is input, display of a window on which the touch for maintaining screen has been determined, regardless of the operation.

2. The information processing apparatus according to claim 1, wherein said controller executes the input operation for a window on which the touch for maintaining screen has not been determined.

3. The information processing apparatus according to claim 2, wherein said display unit displays the at least two windows on divided screens.

4. The information processing apparatus according to claim 2, wherein said display unit displays the at least two windows with superimposing them.

5. The information processing apparatus according to claim 1, wherein the operation is erase of the at least two windows.

6. The information processing apparatus according to claim 1, wherein the operation is erase of a sound corresponding to the at least two windows.

7. The information processing apparatus according to claim 1, wherein the operation is movement of the at least two windows.

8. The information processing apparatus according to claim 1, wherein the operation is input by one of a hardware home button and a displayed software key.

9. The information processing apparatus according to claim 1, wherein said determiner determines, when a time during which a touch on the display region of the at least two windows continues exceeds a threshold, said touch as the touch for maintaining screen.

10. The information processing apparatus according to claim 1, wherein said determiner changes a display of the window so as to recognize the window on which the touch for maintaining screen has been determined.

11. The information processing apparatus according to claim 10, wherein said determiner displays, in a region of the window on which the touch for maintaining screen has been determined, a mark indicating that the touch has been determined.

12. The information processing apparatus according to claim 11, wherein the mark includes an image of a pin representing that the window on which the touch for maintaining screen has been determined is fastened on the screen.

13. The information processing apparatus according to claim 10, wherein said determiner changes a color of the window on which the touch for maintaining screen has been determined.

14. The information processing apparatus according to claim 10, wherein said determiner displays the window on which the touch for maintaining screen has been determined as if the window were recessed.

15. The information processing apparatus according to claim 10, wherein said determiner displays the region on which the touch for maintaining screen has been determined as if the region were recessed.

16. The information processing apparatus according to claim 1, wherein said determiner determines a touch on one of an edge and part of an edge of the window as the touch for maintaining screen on the display region of the window.

17. A method of controlling an information processing apparatus, comprising:
displaying at least two windows;
determining a touch for maintaining screen on a display region of the at least two windows; and
maintaining, even when an operation for the at least two windows is input, display of a window on which the touch for maintaining screen has been determined, regardless of the operation.

18. A non-transitory computer-readable storage medium storing program of controlling an information processing apparatus for causing a computer to execute a method, comprising:
displaying at least two windows;
determining a touch for maintaining screen on a display region of the at least two windows; and
maintaining, even when an operation for the at least two windows is input, display of a window on which the touch for maintaining screen has been determined, regardless of the operation.

19. A method of controlling windows comprising:
determining a touch for maintaining screen on display regions of at least two windows; and
maintaining, even when an operation for the at least two windows is input, display of a window on which the touch for maintaining screen has been determined, regardless of the operation.

20. The information processing apparatus according to claim 9, wherein said determiner changes a display of the window so as to recognize the window on which the touch for maintaining screen has been determined.

21. The information processing apparatus according to claim 9, wherein said determiner determines a touch on one of an edge and part of an edge of the window as the touch for maintaining screen on the display region of the window.
